(19) United States
(12) Patent Application Publication
(10) Pub. No.: US 2008/0217400 A1
(43) Pub. Date: Sep. 11, 2008

(54) System for preventing fraudulent purchases and identity theft

(76) Inventor: Michael D. Portano, Streamwood, IL (US)

Correspondence Address: Meroni & Meroni, P.C., P.O. Box 309, Barrington, IL, 60011, US

(21) Appl. No.: 11/805,526

(22) Filed: May 23, 2007

Related U.S. Application Data
(60) Provisional application No. 60/905,134, filed on Mar. 6, 2007.

(51) Int. Cl. G06K 5/00

(52) U.S. Cl. 235/380

(57) ABSTRACT

An anti-fraud/anti-identity theft system verifies the authenticity of genuine identification devices, including credit cards, cellular telephones, and the like. Likewise the system detects counterfeit credit cards or lines of credit. The system comprises a modified retailer machine that verifies the cards and/or person at the time of buying or selling with a wide variety of security measures. The system further utilizes cellular telephones or electronic devices as a credit card-holding device, which device has a microprocessor computer embedded within the cellular telephone or device, which microprocessor computer can be operated to selectively turn on or turn off availability of credit card funds without closing the credit card account itself.

### PRIOR HISTORY

This non-provisional patent application claims the benefit of U.S. Provisional Patent Application No. 60/905,134, filed in the United States Patent and Trademark Office on Mar. 6, 2007.

### BACKGROUND OF THE INVENTION

1. Field of the Invention

The present invention generally relates to a system for preventing electronic-enabled fraud. More particularly, the present invention relates to a system, device and method for preventing credit card fraud and/or any other types of credit and identity theft by way of a real time interactive security system.

2. Description of Prior Art

U.S. Pat. No. 4,268,715 ('715 patent), U.S. Pat. No. 4,283,599 ('599 patent), and U.S. Pat. No. 4,315,101 ('101 patent), which issued to Atalla, disclose certain methods and apparatuses for improving the security of data transmissions between stations and for controlling secured transactions from remote locations in a data-transfer system. The method and apparatus obviate the need for transmitting user-identification information such as personal number (PIN) from station to station, e.g., from the station utilized by the user to enter his PIN and initiate a transaction, to the station that processes the transaction. Also, for added security, the method and apparatus providing the encryption (encoding) and decryption (decoding) of data during a transaction using encryption and decryption keys produced from different (independent) PINs. The apparatus includes at least one irreversible algorithm module, a random number generator and at least one data file (e.g., disc or magnetic tape storage). The apparatus also includes a comparator or, alternatively, an encoding algorithm module and a matching decoding algorithm module. In addition, a data-transfer system obviates the need for paired encryption/decryption modules on a data link while nevertheless maintaining a high level of security in the data transferred. This facilitates remote control of data transfers between locations within the system, enables use of conventional data links, and permits convenient changes of and additions to the files of stored codes for the system without compromising the security of data transfers or of identifying codes for authorized individuals.

U.S. Pat. No. 4,326,098 ('098 patent), which issued to Bouricius et al., provides a systems for both electronic signature and message verification with a minimum of excess coding information on an instantaneous basis and is easily restartable in a store and forward environment. The system is based on the concept of a vault or central authority. The vault is in essence a physically secured Authenticator designed as a hardware automation which is not under control of any operating system. The system is a terminal based network wherein all terminals or users may communicate directly or through a central CPU. All secure electronic signature verification transactions must be transacted through the central facility which includes said vault. The vault and all terminals include an identical key-controlled block-cipher cryptographic facility wherein each user at a terminal has access only to his own key and wherein the vault has access to all user keys. At the end of a transaction, a user A (originator) and a user B (receiver) each have uniquely encrypted messages which can be utilized in later arbitration proceedings wherein user A cannot later deny having sent a message or its contents and similarly user B cannot deny having received the message or its specific content. The vault provides facilities for effective legal arbitration and is also simple to operate in such an “n-to-n” network without using more than one key per person.

U.S. Pat. No. 4,776,003 ('003 patent), which issued to Harris, discloses cellular mobile telephone stations which are intended for installation and use in public transportation facilities, e.g., taxicabs, limousines, rental cars, etc. are equipped to support credit card billing of transient customers for use of the station services. The cellular pay stations, from the viewpoint of the serving cellular carrier facilities, are indistinguishable from standard cellular mobile stations. The activities of the credit card stations are supported by an administrative processor which is connected to a standard telephone line of the public switched telephone network. The cellular stations and the administrative processor exchange data messages over a standard telephone connection. The data messages are used to establish operating options and parameters of the credit card mobile stations, compile records in the administrative processor to permit the assignment of billing responsibility to transient customers for use of the stations and connected facilities, and control the stations for administrative and commercial reasons.

U.S. Pat. No. 4,845,740 ('740 patent), which issued to Tokuyama et al., discloses radio phone equipment for credit cards adapted to transfer part or a whole of credit card or charge card information read by a card reader as well as a dial number dialed by a key pad to a mobile telecommunication switching office by means of a modem and a transmitter/receiver, and in case of said credit card or charge card being valid, switching, on the basis of a designation on a voice channel transmitted from said mobile telecommunication switching office, or transmitting and receiving frequency to said voice channel to construct a speech channel, and furthermore detecting on-hook of a handset produced upon finishing talking to reset the equipment.

U.S. Pat. No. 4,860,336 ('336 patent), which issued to D'Avello et al., discloses a credit-card radiotelephone for a vehicle with a door includes a radio transceiver and a control unit with a telephone handset, credit card reader, hookswitch and door switch. The telephone handset has a microphone, a speaker, and a dial. The radio transceiver has a transmitter, a receiver, and a first microprocessor for electronically locking and unlocking the radio transceiver. The credit card reader reads a credit card number and produces an output indicating the read credit card number. The control unit also includes a second microprocessor coupled to the credit card reader for receiving the read credit card number and determining if the read credit card number is valid, coupled to the first microprocessor, hookswitch and the dial for electronically unlocking said transceiver and placing telephone calls when the read credit card number is determined to be valid, and coupled to the door switch for electronically locking said transceiver means when the door is opened.

U.S. Pat. No. 4,965,821 ('821 patent), which issued to Bishop et al., relates to system utilizing a cellular mobile radiotelephone and a public switching telecommunication network (PSTN) for entering into rental agreements and for accruing and billing the resulting rental charges associated with the rental of equipment, such as automobiles. The automobiles to be rented incorporate credit-card-activated, intelligent, cellular mobile radiotelephones. Upon entry into the automobile, a customer slides a card through a card reader included therein. The card reader transfers data encoded on the card to the radiotelephone whereupon the radio telephone establishes, via the PSTN, a communications link with a processor. In response to processor-originated voice prompts that the radiotelephone conveys to the customer, the customer then uses a keypad of the radiotelephone to enter data necessary to compose the rental agreement. Based on this data, as well as a renter profile included in a database accessible by the processor, the processor causes a rental agreement form to be printed at a location near the automobile. The customer then needs only to sign the completed written contract form at the exit location in order to drive away with the rental automobile. Upon return of the automobile, the customer enters a predetermined return code, which results in another call to the processor. Again, in response to processor-originated voice prompts, the customer enters data on the radiotelephone keypad in order to calculate rental charges. These charges are then automatically debited to an account indicated by the customer, and a written receipt is presented to the customer.

U.S. Pat. No. 4,975,942 ('942 patent), which issued to Zebryk, relates to a credit/calling card pay telephone method and system, which system employs appropriate expanded local intelligence at the telephone instrument unit for enabling local card checking and call transaction record keeping, and interfacing with a PC host computer periodically automatically to transmit batches of such records to the computer for locally generating customer billing thereat.

U.S. Pat. No. 5,301,223 ('223 patent), which issued to Amadon et al., discloses a method and apparatus for use in a mobile telephone rental system in which credit card information is communicated between the mobile telephone unit and a Voice Response System for customer registration and remote programming of mobile telephone unit features and NAM settings; communicating data between the Voice Response System and a Registration System for customer credit card validation; communicating data between the Registration System and a credit card clearinghouse for credit card approval or decline; communicating data between the Registration System and a plurality of Collector Systems for call rating and billing; communicating data between the Registration System and an Administration System for providing rated call information to the reseller; and communicating data between the mobile telephone unit and an Indirect System for establishing service in cellular areas without Collector System service. Data read from the mobile telephone units are transmitted in variable length, encrypted and error protected Packet Data Units (PDUs).

U.S. Pat. No. 5,615,268 ('268 patent), which issued to Bisbee et al., discloses a system and method that implements digital encryption for the electronic transmission, storage and retrieval of authenticated documents and that enables the establishment of the identity of the originator of an electronic document and of the integrity of the information contained in such a document. Together these provide irrevocable proof of authenticity of the document. The system and method make it possible to provide “paper-less” commercial transactions, such as real-estate transactions and the financial transactions secured by real estate. A Certification Authority provides tools for initializing and managing the cryptographic material required to sign and seal electronic documents. An Authentication Center provides “third party” verification that a document is that executed and transmitted by the document's originator. The Certification Authority and the Authentication Center together provide for third-party assumption of the risk of the authenticity of documents, an audit trail of the documents, and storage and retrieval of the documents by authorized parties. The system and method eliminates the need for “hard copies” of original documents as well as hard-copy storage. Retrieval of an authenticated document from the Authentication Center may be done by any number of authorized parties at any time by on-line capability.

U.S. Pat. No. 5,629,678 ('678 patent), which issued to Gargano et al. discloses an apparatus for tracking and recovering humans utilizes an implantable transceiver incorporating a power supply and actuation system allowing the unit to remain implanted and functional for years without maintenance. The implanted transmitter may be remotely actuated, or actuated by the implantee. Power for the remote-activated receiver is generated electromechanically through the movement of body muscle. The device is small enough to be implanted in a child, facilitating use as a safeguard against kidnapping, and has a transmission range which also makes it suitable for wilderness sporting activities. A novel biological monitoring feature allows the device to be used to facilitate prompt medical dispatch in the event of heart attack or similar medical emergency. A novel sensation-feedback feature allows the implantee to control and actuate the device with certainty.

U.S. Pat. No. 5,729,591 ('591 patent), which issued to Bailey, discloses a credit card operated cellular telephone comprising an interface assembly that allows addition of a credit card reader and an electronics board thereto. The interface assembly mates with the existing telephone and battery, and allows a cellular telephone to be easily modified.

U.S. Pat. No. 5,848,161 ('161 patent), which issued to Luneau et al., describes a networked communications system comprising a client unit, a secured host server, and a company subscriber unit, a method for providing secured commercial transactions via the networked communications system. The method includes the steps of providing a secured transmission path via the networked communications system between the client unit and the secured host server, presenting the client unit with an order form in which commercial information is to be entered via the secured transmission path, receiving the commercial information transmitted via the secured transmission path by the client unit at the secured host server, maintaining the commercial information solely in the dynamic memory of the secured host server, encrypting the commercial information in response to the step of receiving the commercial information, erasing the dynamic memory of the secured host server in response to the step of encrypting the commercial information, and forwarding the encrypted commercial information via the communications network from the secured host server to the company subscriber unit.

U.S. Pat. No. 5,850,196 ('196 patent), which issued to Mowers, describes a new tracking device for pets for locating objects. The inventive device includes a microchip transmitter encapsulated within a biologically inert material and coupled with respect to a pet and communicating with a satellite system.

U.S. Pat. No. 5,850,599, ('599 patent), which issued to Seiderman, discloses a portable cellular telephone credit card calling system operable in conjunction with a cellular telephone, a local cellular network and an IXC in a telecommunications network. The portable cellular telephone has a handset and a transceiver unit and a credit card and electronic control interface electronically interposed between the handset and the transceiver unit. The interface unit has a credit card reader and an electronic system which initially validates the credit card. The cellular telephone also includes electronic circuitry which establishes a first telephone communications link with the network and transmits, via the transceiver unit for the phone, to the network, credit card data, a cellular telephone ID data and the telephone number input into the handset by the user. Upon receipt of at least the credit card data, a network transceiver verifies the validity of the user's credit card. After the credit card has been validated by the LXC through a verification or validation computer service, the network transceiver then completes a further telephonic communications link between the cellular telephone, operated by the user, and the telephonic device associated with the input telephone number, that is, the third party's telephone. Since the network transceiver does not complete the call to the third party prior to validation of the user's credit card, the system operates in real time. Further, in a preferred embodiment, the network transceiver provides some type of indication to the credit interface unit that the credit card has been validated. Thereafter, the user is permitted to make additional cellular telephone calls without requiring further validation of the credit card data by the network transceiver.

U.S. Pat. No. 6,005,939 ('939 patent), which issued to Fortenberry et al., discloses a method and apparatus for obtaining user information to conduct secure transactions on the Internet without having to re-enter the information multiple times is described. The method and apparatus can also provide a technique by which secured access to the data can be achieved over the Internet. A passport containing user defined information at various security levels is stored in a secure server apparatus, or passport agent, connected to computer network. A user process instructs the passport agent to release all or portions of the passport to a recipient node and forwards a key to the recipient node to unlock the passport information.

U.S. Pat. No. 6,073,854 ('854 patent), which issued to Bravenec et al. describes a card for use as a telephone authorization card or the like is comprised of a layer of a backing material such as a stiff plastic material which has some pliability. A thin sheet lenticular lens material has a flat surface on which is printed selected interlaced images. On the other side of the lens material is formed a plurality of lenticules through which the images are viewed. The flat side of the lenticular material is secured to one face of the backing in a convenient manner. A cutting tool is now used to form an opening in the outer face of the lenticules and a programmed microchip is inserted in the opening and secured in place. On the outer face of the backing material a magnetic strip containing magnetically encoded indicia is secured. The card is usable in a reader which can scan the magnetic strip and read information from the microchip to allow the user to place a telephone call or conduct other transactions.

U.S. Pat. No. 6,148,405 ('405 patent), which issued to Liao et al., describes a method and system for establishing an authenticated and secure communication session for transactions between a server and a client in a wireless data network that generally comprises an airnet, a landline network and a link server therebetween. The client having limited computing resources is remotely located with respect to the server and communicates to the server through the wireless data network. To authenticate each other, the client and the server conduct two rounds of authentication, the client authentication and the server authentication, independently and respectively, each of the authentication processes is based on a shared secret encrypt key and challenge/response mechanism. To reach for a mutually accepted cipher in the subsequent transactions, the server looks up for a commonly used cipher and forwards the cipher along with a session key to the client. The subsequent transactions between the client and the server are then proceeded in the authenticated and secure communication session and further each transaction secured by the session key is labeled by a transaction ID that is examined before a transaction thereof takes place.

U.S. Pat. No. 6,189,787 ('787 patent), which issued to Dorf, discloses a multifunction card system which provides a multifunction card capable of serving as a prepaid phone card, a debit card, a loyalty card, and a medical information card. Each card has an identification number comprising a bank identification number which assists in establishing communications links. The card system can be accessed from any existing point-of-sale (POS) device. The POS device treats the card as a credit or debit card and routes transaction data to a processing hub using the banking system. The processing hub coordinates the various databases corresponding to the various functions of the card.

U.S. Pat. No. 6,435,406 ('406 patent), which issued Pentel, discloses a cell phone or other wireless telecommunications device is used to communicate with an ordering station over a cellular telephone communications network and telephone line. A coded item number can be entered and transmitted to the ordering station, which decodes the coded item number and enters the order into the point of sale system by a communications link. Further, data such as the identity of the user by physical characteristics, personal identification numbers, credit card or charge information, and location of the sender of the data can also be obtained from the wireless communications device and transmitted to the order station. In this manner remote ordering of goods or services can be communicated and transactions completed without having to be present at the sales point.

U.S. Pat. No. 6,480,957 ('957 patent), which issued to Liao et al., describes a method and system for establishing an authenticated and secure communication session for transactions between a server and a client in a wireless data network that generally comprises an aimet, a landline network and a link server therebetween. The client having limited computing resources is remotely located with respect to the server and communicates to the server through the wireless data network. To authenticate each other, the client and the server conduct two rounds of authentication, the client authentication and the server authentication, independently and respectively, each of the authentication processes is based on a shared secret encrypt key and challenge/response mechanism. To reach for a mutually accepted cipher in the subsequent transactions, the server looks up for a commonly used cipher and forwards the cipher along with a session key to the client. The subsequent transactions between the client and the server are then proceeded in the authenticated and secure communication session and further each transaction secured by the session key is labeled by a transaction ID that is examined before a transaction thereof takes place.

U.S. Pat. No. 6,584,309 ('309 patent), which issued to Whigham, discloses a system and method for purchasing a product from an automatic vending machine by means of a consumer's cellular telephone. The consumer requests a product available from the vending machine by dialing a specified telephone number which connects the consumer's cellular telephone to a server operated by a billing agency. The billing agency may include the provider of the product, the telephone company that provides the cellular telephone service, a credit card company, or a bank that has issued a debit card. The server recognizes the request for the product, creates a transaction record, and communicates a vend code to the consumer. The transaction record includes a billing record that the billing agency uses, to bill the consumer for the requested product and an inventory record that the product provider uses in connection with restocking the vending machine. Upon receiving the vend code from the server, the consumer transmits the vend code to the vending machine. The vend code may be an RF code, an audible tone code, or a manual code. Upon receipt of the vend code from the consumer, the vending machine dispenses the requested product.

U.S. Pat. No. 6,760,796 ('796 patent), which issued to Rossmann et al., describes a smart card and a method of operating the smart card in which the smart card has input/output means enabling the smart card to receive and transmit data regarding individual financial transactions. The smart card has a microprocessor which incorporates a read only memory, a random access memory and input/output ports. The smart card is able to communicate through the ports when suitably positioned within a smart card reader. The internal operations of the smart card are controlled by the microprocessor as determined by program microinstructions that are stored in the read only memory. The microinstructions include a number of application programs enabling the smart card to conduct financial transactions, other related applications and transaction logging operations. The smart card has a secure area and an unsecured area within the random access memory. The microprocessor is programmed to store in the unsecured store area individual transactions which may be automated transactions using the smart card or manual transactions entered as updates into the smart card. The microprocessor is programmed to transfer transactions from the unsecured store area and consolidate them into a consolidated log of transactions in the secured area. As a result, an updated statement of cashflow is available to the user from the consolidated log.

U.S. Pat. No. 6,947,908 ('908 patent), which issued to Slater, discloses a system and method for a customer and merchant to perform an on-line, and in some cases, real-time financial transaction from a personal computer or similar processing terminal over a public access communications network utilizing a universally acceptable electronic financial transaction instruction that debits a customer's selected account and notifies a merchant that a credit is due or forthcoming and a service provider. The financial transaction instruction is provided in a secured format for transactions sent over the public access communications network, which is external from any other conventional open or closed communication channels used for performing financial transactions.

U.S. Pat. No. 7,059,520 ('520 patent), which issued to Shtesl, discloses a universal credit card with a cellular telephone that has inside of an outer housing and adjacent to a side thereof a magnetic reader/writer capable of reading data from a magnetic strip of a credit card. Along a side of the outer housing adjacent the magnetic reader/writer is a wide and deep enough slit to swipe the credit card. When a template credit card is swiped through the slit, a magnetic strip of the template credit card reads or writes data from at least one credit card that the user selected on the telephone's keypad from a plurality of credit cards whose data had been entered into memory. A controller and software operate the magnetic reader/writer the user's keypad selection. Alternatively, there is a slot in the outer housing rather than a slit, and insertion and/or removal of a credit card in the slot constitutes swiping the credit card.

U.S. Pat. No. 7,113,099 ('099 patent), which issued to Tyroler et al., describes tracking, presence verification, and locating features which are incorporated into a security system that includes a user interface device with a display, keypad and associated transceiver. Wireless RF electronic tags are attached to different objects, e.g., an inanimate object, or a living being such as a child or pet. To verify the presence of an object associated with a tag, the user instructs the user interface device to transmit a wireless signal to the tag. The tag responds, when within range, by returning a wireless signal. In another aspect, a person is detected such as at the entry to a home, and a low-power transmitter at the entry sends a signal to the electronic tag. The electronic tag responds by transmitting data to the security system to cause it to take a desired action. The presence of a person, such as a child, in an unauthorized area can trigger an alarm.

United States Patent Application Publication No. U.S. 2001/0034725, which was authored by Park et al., teaches an electronic payment system and method comprising an anonymous represent payment card to ensure the anonymity of a client and availability for electronic commerce and real transactions. The electronic payment system includes: an electronic payment web server connected to a client terminal through the Internet, for providing an identification number and password to a client who applies for a registration, providing a representative payment card to the client who applies for the card, and downloading an electronic wallet driving program to an web browser of the client terminal; and a payment gateway server connected to the electronic payment web server by a leased line, for receiving a representative payment card issued by a financial system of a financial company and to be provided through the electronic payment web server to the client who applies for the card, incorporating the identification number of the representative payment card into an electronic wallet corresponding to the client's identification number, receiving a client's product purchase information from the electronic wallet driving program downloaded to the client terminal, requesting an approval for payment with the representative payment card to the financial system in response to a payment approval request from an Internet shopping mall server, and informing the Internet shopping mall server of the result of payment approval request from the financial system. The client's authentication is achieved by the identification number and password, so that the representative payment means can be used in affiliated electronic commerce shops with secured anonymity. The representative payment card can be efficiently used in existing credit card-affiliated shops using its identification number.

United States Patent Application Publication No. U.S. 2002/0035686, which was authored by Creighton et al., teaches methods and systems that enable organizations to make secure a wide array of electronic transactions such as business-to-business transactions over corporate extranets. One aspect of the present invention allows companies to create an extranet with business partners that they know. The extranet host provides to a certification authority a shared secret and the names of the business partners that are authorized to access the corporate extranet. If the requestor's shared secret and name matches a digital certificate is automatically issued. The invention allows a business to issue secured socket layer (SSL), Object Signing, Client authorization and secure email certificates to internal employees as well as issuing client authentication certificates to business partners.

United States Patent Application Publication No. 2004/0138991, which was authored by Song et al., teaches anti-fraud measures which are implemented through networks for transactions using payment documents such as checks, letters of credit, notes, etc. as the payment instrument. The payer is authenticated and the availability of funds is verified by the payer's financial institution before the transaction is completed and the funds are immediately secured during the transaction. Since the transaction details are registered for verification purposes, neither payee nor third party has a chance to alter any part of the transaction. The payment document may be an Anti-Fraud Check which has been endorsed with an anti-fraud system supplied “TIN” or “FSTIN” that provides better fraud protection than a conventional cashier's check or a t a method for performing secure electronic transactions on a computer network, the network comprising a buyer's computer, a vendor server, a creditor server and a security server. The buyer's computer has a fingerprint file stored in the memory thereof. The method includes the steps of: i) the buyer computer requesting to purchase merchandise to the vendor server, the purchase request including said buyer computer's IP address; ii) the buyer computer selecting a predetermined form of secured payment method; iii) the payment method selection causing the vendor server to transmit to the security server a request for confirmation of the buyer computer's identity at the buyer computer's IP address; iv) the confirmation request causing the security server to send a retrieval request to the IP address, the retrieval request including a retrieval program for detecting and retrieving the buyer's computer's fingerprint file, and the retrieval request further comprising a response request asking for confirmation of the purchase request; whereby a positive response from the buyer's computer to the security server accompanied by the fingerprint file causes the security server to confirm the buyer computer's identity to the vendor server and to approve the purchase.

United States Patent Application Publication No. 2004/0139014, which was authored by Song et al., teaches an effective and efficient solution with anti-fraud protection to conducting remote transactions using cash as the payment instrument at any time, anywhere over the world is implemented through networks from general-purpose financial accounts such as checking, savings, credit card, or debit card accounts. The prayer is authenticated and the availability of funds is verified by the payer's financial institution before the transaction is completed. The payee is authenticated with a machine-readable identification document before the cash payment is issued. The entire transaction is secured in such a way that no party has a chance to alter or dispute any part of the transaction.

United States Patent Application Publication No. 2005/0102502, which was authored by Sagen, relates to conferencing and data recording, in particular to providing secured and verified transactions by means of biometrics. The uniqueness of biometrics is combined with the robustness and reliability of PKI for use in conference applications. The invention is about identifying an individual from a biometric pattern, like the iris of the individual's eye, by means of an iris recognition system. The recognition system then provides the identity of the individual, which is further used to provide secure and reliable digital actions or verifications like authentication, signing and encryption.

United States Patent Application Publication No. 2005/0108177, which was authored by Sancho, teaches a method for performing secure electronic transactions on a computer network, the network comprising a buyer's computer, a vendor server, a creditor server and a security server. The buyer's computer has a fingerprint file stored in the memory thereof. The method includes the steps of: i) the buyer computer requesting to purchase merchandise to the vendor server, the purchase request including said buyer computer's IP address; ii) the buyer computer selecting a predetermined form of secured payment method; iii) the payment method selection causing the vendor server to transmit to the security server a request for confirmation of the buyer computer's identity at the buyer computer's IP address; iv) the confirmation request causing the security server to send a retrieval request to the IP address, the retrieval request including a retrieval program for detecting and retrieving the buyer's computer's fingerprint file, and the retrieval request further comprising a response request asking for confirmation of the purchase request; whereby a positive response from the buyer's computer to the security server accompanied by the fingerprint file causes the security server to confirm the buyer computer's identity to the vendor server and to approve the purchase.

United States Patent Application Publication No. 2005/0137949, which was authored by Rittman et al., teaches a system and a computer software invention for automatic characterized and prioritized credit cards transactions and charge system. Typical credit cards accounts are categorized by their characters. These characters are offered by the credit cards corporations to its customers and include best interest rates, membership fees, cash advanced, line of credit, benefits like mileage, gift certificates, and similar. When a credit card user is using his/hers account, most of the cases it is done arbitrarily or by credit availability. In many cases the credit card user is not utilizing his/hers other cards lower interests and benefits. Using an automated software tool and method, as we will describe in this invention, a credit card user combines all of his/hers credits cards accounts into one credit facilitate account. This one credit system, automatically prioritize and charges the best credit card account according to the user's best interest, furthermore it will combine all the line of credits from his/her credit cards into one “big” line of credit. The one credit system accumulates the users' credit cards available credit into one account. When a transaction is made, the system searches the user's most beneficial credit card account and charges the amount to it. The most beneficial account is defined by the system according to its characteristics and benefits. These characteristics are low interest, additional benefits (mileage, gift points, etc) provided by credit cards corporations and/or financial institutions. The system may automatically split the full amount between few accounts for the best interest rate and/or other benefits. The user gets a monthly statement that shows the total charges and makes one payment which will be distributed among the different credit card accounts that he/she combined to the one credit card account. The statement shows to which account the charge was made and the reasons for the credit card account selection. Also the system provides a minimal payment due to cover all necessary credit card accounts. User can setup the system to pay the minimum amount required or more according to desire. Using this system, method and computer software user may save enormous amount of money and gain all the possible additional benefits using their credit cards. The system is a secured web based computer software and method that allows users to define and prioritized their credit accounts for automatic selection according to priorities and benefits. The system automatically identifies the user's credit accounts limits and availability and charges the best amount for the user's best benefits. The system also covers refunds in a similar way. All refunds will be credited to the best credit account(s) according to the user's preset priorities.

From a consideration of the foregoing, it may be seen that the prior art does not teach a system for preventing fraudulent purchases or transactions comprising, in combination, a personal send-receive purchasing unit; a vendor establishment or system; a financial establishment or system; a global positioning system; and means for globally tracking the personal send-receive purchasing unit in real-time. Accordingly, the prior art perceives a need for a fraud-prevention system of the foregoing type as a means to enhance secure transactions and contribute to growth of financial markets.

### SUMMARY OF THE INVENTION

The present invention essentially provides an identification-authenticating (anti-fraud) tracking system and prevents identity theft or misrepresentation or use of other people's identification means and/or credit cards. The system functions to authenticate and monitor purchases for preventing fraudulent purchases, and provides a protective system for preventing identity misrepresentation or use of other people's credit cards and identification (ID) means in real time. The system comprises, in combination, a personal send-receive unit; at least one vendor establishment; at least one financial establishment; a retailer machine Global Anti-Fraud System (GAFS) that verifies buyer and/or seller information such as identification. The GAFS comprises a computer system of embedded coding with a data base of codes for security reasons.

The personal send/receive unit (SRU) may be embodied by printed code(s) on paper notes, a cellular telephone, mobile electrical device, a key fob, a chip-embedded credit card, or similar other personal send/receive unit for effecting a purchase. Also, for additional protection the owner of the credit card can turn off the card and it will automatically turn off at each purchase. The user of the credit card can call up the financial establishment or GAFS to turn on credit cards and set amount of fund to be used from available amount of fraud in each credit card limit set by the financial establishment.

Essentially, the SUR is a personalized, hand held payment device, with a coding system data base with a security system. It may be defined as a user segment of a secured transaction system and thus preferably comprises means for verifying or authenticating device usage by a single designated user with signal transmitting means for wireless transmission of a purchasing signal to a vendor establishment and for wireless transmitting. The signal transmitting means are designed to effect a secure purchase at vendor establishment and to computer network (GAFS) security system to ensure transaction authenticity of ownership.

The vendor establishment comprises means for wirelessly receiving transmitted data. It serves as a ground base establishment for purchasing signals and means for processing received purchasing signals. The vendor establishment essentially fulfills the function of filling an order as requested by a single user via the purchasing signals. The financial system is in communication with the vendor establishment and comprises means for receiving, holding, and sending single user funds. It is contemplated that the financial system may well function to electronically send single user funds to the vendor establishment for electronic funds settlement.

### BRIEF DESCRIPTION OF THE DRAWINGS

Other features of my invention will become more evident from a consideration of the following brief description of reference numerals and patent drawings:

FIG. 1 is a schematic depiction of a user traveling to a so-called “Global Anti-Fraud System” (GAFS) depot for obtaining a GAFS identification unit with smart chip technology.

FIG. 2 is a GAFS credit machine located at the GAFS depot otherwise depicted in FIG. 1, which credit machine depicts various means for inputting and outputting data.

FIG. 3 is a generic representation of three structures otherwise centrally depicted in FIG. 2, namely a finger print reader device, an identification/credit card/cell phone reader, and an implant chip reader.

FIG. 4 is a generic representation of one structure otherwise depicted in FIG. 2 for reading paper-based transaction materials such as checks, or money orders, or bank notes, or food stamps.

FIG. 5 is a generic representation of a telephone handset for enabling oral/aural communications via the unit otherwise depicted in FIG. 2.

FIG. 6 is a generic representation of first and second light display devices for signaling normal operating (a green light) mode or error (a red light) mode.

FIG. 7 is a generic representation of a camera system having three input windows for receiving (1) visible light wave electromagnetic radiation input, (2) infrared wave electromagnetic radiation input, and (3) radio wave electromagnetic radiation input.

FIG. 8 is a generic representation of a system of visual output displays, one being a side view of a visual output display, and two front plan views of visual output displays.

FIG. 9 is a generic representation of first and second loudspeakers for enabling aural delivery of information.

FIG. 10 is a generic representation of a machine (positioned at the bottom of the figure) for creating new identification cards, the camera (positioned at the upper left of the figure) otherwise depicted in FIG. 7, and a credit card with smart chips (positioned at the upper right of the figure).

FIG. 11 is an enlarged generic depiction of an identification activator center device otherwise part of the machine for creating new identification cards shown in FIG. 10 for activating identification cards, credit cards, cellular telephones, smart chips, or similar other device.

FIG. 12 is a generic depiction of a smart chip tester and/or television screen otherwise part of the machine for creating new identification cards shown in FIG. 10.

FIG. 13 is a new identification card with smart chip technology otherwise shown at the upper right in FIG. 10.

FIG. 14 is a generic first sequence of codes that may be used in the smart chip of the present invention.

FIG. 15 is a generic second sequence of codes that may be used in the smart chip of the present invention.

FIG. 16 is a generic third sequence of codes that may be used in the smart chip of the present invention.

FIG. 17 is a generic fourth sequence of codes that may be used in the smart chip of the present invention.

FIG. 18 is a generic depiction of a credit card with embedded smart chip to be utilized in combination with the so-called GAFS machine of the present invention.

FIG. 19 is a depiction of the credit card otherwise shown in FIG. 18 being read.

FIG. 20 is a generic depiction of an identification card with embedded smart chip technology.

FIG. 21 is a generic depiction of a food stamp.

FIG. 22 is a depiction of the food stamp otherwise shown in FIG. 21 being swiped through a card reader of the GAFS machine.

FIG. 23 is a frontal and side view depiction of a generic cellular telephone.

FIG. 24 is a depiction of multiple smart chips housed within the cellular telephone otherwise depicted in FIG. 23.

FIG. 25 is a flow chart type diagram showing cellular telephone call(s) being sent and received simultaneously.

FIG. 26 is a flow chart type diagram showing certain methodology for effecting a purchase via a cellular telephone at a point of sale.

FIG. 27 is a generic depiction of a cash register.

FIG. 28 is a cellular telephone credit card being used to check the retail identification versus the physical location of the cellular telephone. The GAFS machine is wirelessly reading coded information from the cellular telephone.

FIG. 29 is a depiction of the GAFS machine being used to wirelessly read coded information from the cellular telephone.

FIG. 30 is a generic depiction of a money order travel check or bank check note showing the paper before (top) and after (bottom) coding.

FIG. 31 is a schematic flow chart type depiction of the note otherwise depicted in FIG. 30 being swiped at a point of sale swipe device, which device communicates with a bank, a GAFS machine, and a creditor.

FIG. 32 is a generic representation of a map in real time showing the location of a detected fraud in progress.

FIG. 33 is a generic representation of a police or GAFS command center in which all camera information is being sent live to multi-locations to apprehend the person(s) committing the fraud or crime.

FIG. 34 is a representation of the unlawful transactor traveling in a vehicle, which vehicle can be tracked via cameras mounted in the vicinity of the unlawful transaction and via the unlawfully utilized personal send-receive unit (cellular telephone, credit card, etc.) fraudulently used by the unlawful transactor.

FIG. 35 is a computer simulation of the vehicle otherwise depicted in FIG. 34 on a virtual map, which map can be used to track the unlawful transactor.

FIG. 36 is a sequential depiction of visual displays depicting the GAFS machine defuzzing photos of a person for positive identification.

FIG. 37 is a representation of a map showing the location of a cellular telephone being fraudulently used.

FIG. 38 is a bird's eye view a vehicle approaching an intersection, which intersection is outfitted with video camera hardware for capturing vehicle license plate information.

FIG. 39 is a camera shot of the vehicle license plate information otherwise referenced in FIG. 38.

FIG. 40 is a depiction of a personal send-receive unit of the present invention.

FIG. 41 is a flow chart type depiction of item delivery in authenticated versus non-authenticated scenarios.

FIG. 42 is a flow chart depiction of item pick up in authenticated versus non-authenticated scenarios.

FIG. 43 is a computer monitor visual display showing items available for purchase.

FIG. 44 is a flow chart depiction of Internet-based purchasing according to the present invention.

FIG. 45 is a flow chart depiction of a delivery transaction according to the present invention.

FIG. 46 is a mobile GAFS credit machine according to the present invention.

FIG. 47 is a flow chart type depiction of the mobile credit machine otherwise depicted in FIG. 46 being used for two types of transactions, namely, a food vendor and taxi service.

FIG. 48 is a generic representation of a magnetic strip credit card within a housing of a cell phone showing the before and after pictures strip closed in a cell phone and pulled out from the side of the cell phone ready for use.

FIG. 49 is a flow chart of pulling out a magnetic strip from a device such as a cell phone from a side compartment.

FIG. 50 is a flow chart of turning on any credit card with Smart Chip Technology (SCT) in the cell phone, mobile telecommunications device, non-electric device and standard credit card with (SCT) or without (SCT).

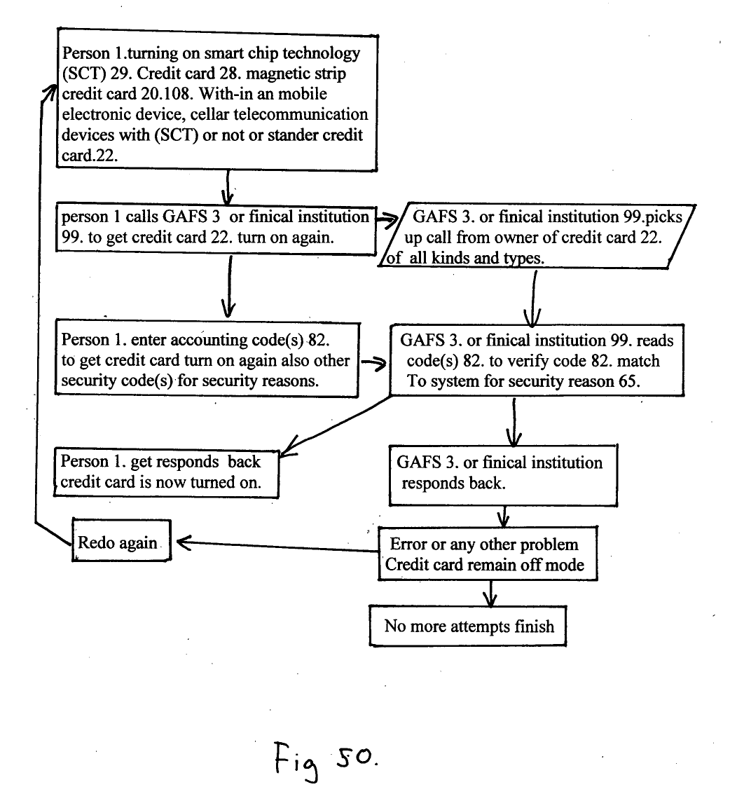

FIG. 51 is a sequential type depiction of a combination credit card/cell phone, the FIG. 1^{st} depicting a closed cell phone, the FIG. 2^{nd} showing the cell phone compartment open with the credit card(s) in it, and the FIG. 3^{rd} showing the credit card out from the cell phone.

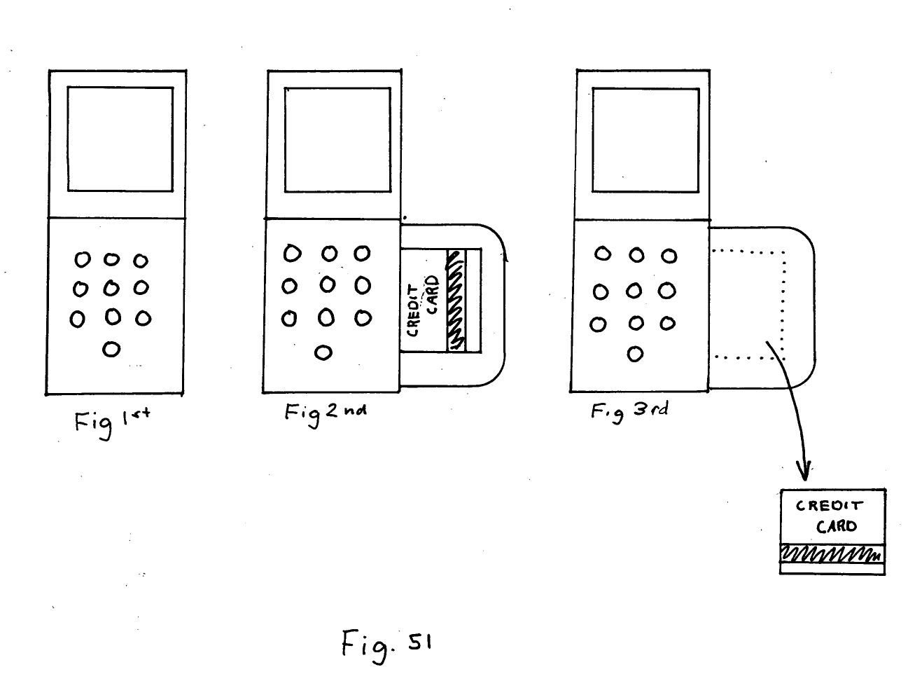

### REFERENCE NUMBER LISTING

1. User/Person
2. GAFS ID center or governmental agency
3. GAFS machine/computer system
4. Camera for GAFS
5. Visual Output Displays
6. Check Reader
7. Speaker
8. Telephone Handset
9. Fingerprint Reader
10. Smart Chip Reader
11. Indicator Lights
12. Retailer GAFS computer
13. Recipe Machine
14. TV for retailer
15. Implant Chip Reader
16. ID maker or credit card maker
17. New ID or credit card with smart chip technology
18. Set of numbers and letters for coding
19. Set of numbers and letters completed
20. Back of credit card or ID with magnetic strip
21. Energy field (radio wave transmission) from GAFS
22. Card or ID or credit card
23. Food stamp card or Medicare card
24. Food Stamp
25. Food stamp being read the GAFS computer
26. Cell Phone or Mobile Device
27. Cell Phone Computer Chip
28. Cell Phone Credit Card Chip
29. GAFS smart chip
30. Multi-credit cards within cell phone
31. Cash Register
32. Cell phone credit card being read at GAFS computer
33. Travel check, money order or bank check note before coding
34. Finish Check with Coding
35. Travel check being read through GAFS computer system
36. Dial up to get codes for different location to verified check
37. Starred Camera Locations
38. Police command center or GAFS command center
39. Multi TV
40. Official
41. Box to input information to command center
42. Rewind TV
43. Headset or Microphone to Talk
44. Map of Area
45. Car in Photo
46. ID location of camera
47. Map of car at location with camera locations
48. Photo of person de-fuzzing for positive identification
49. Camera on Telephone Pole
50. Snapshot of Car
51. ID checks and hand held device
52. ID checker at location without the need of a credit card
53. Computer
54. Internet connection (example: EBAY)
55. Retail caller ID machine
56. Store for Location
57. Coding system for ID cards, cell phones or any device of importance
58. Codes in Chip
59. Codes in Chip being
60. Computer Codes in Chip
61. Systems checks code to start smart chip
62. Sells or buys goods and services
63. Smart Chip Technology
64. Answer from Smart Chip Technology
65. Security system of GAFS
66. Information of Person for Matching
67. Photo of Person
68. Print of Fingers of Person
69. DNA of person
70. Voice of Person
71. Tester of Smart Chip Technology
72. ID identification codes using state's driver licenses
73. Dial up code to start credit card in device
74. Question from GAFS to set codes out of smart chip
75. Bank's codes or check
76. GAFS codes on check
77. Third Party Codes on Checks
78. Check or money order ID number
79. Fake ID cell phone, credit card, etc.
80. Web Site Phone Number
81. Cell Phone Number Enter Website
82. Security Code to Complete Transaction
83. Retailer Phone Number
84. Mobile Credit Machine
85. Price of Service
86. Credit Card Holder Device
87. Radius 1
88. Radius 2
89. Radius 3
90. Earth
91. Trilateration Depictions
92. Earth-Orbiting Satellites
93. Radio Wave Input Window
94. Infrared Wave Input Window
95. Visible Light Wave Input Window
96. Red Light Display
97. Green Light Display
98. Structure-Receiving Aperture
99. Financial Establishment
100. Personal send-receive purchasing unit
101. Antenna
102. Personal send-receive unit visual display
103. Computer monitor display
104. Good to be purchased
105. Telephone number
106. Global Positioning System or Global Satellite Navigation System
107. Tracking Device
108. Magnetic Strip of Credit Card or Device
109. Credit Card Holding Compartment

### DESCRIPTION OF THE PREFERRED EMBODIMENT(S)

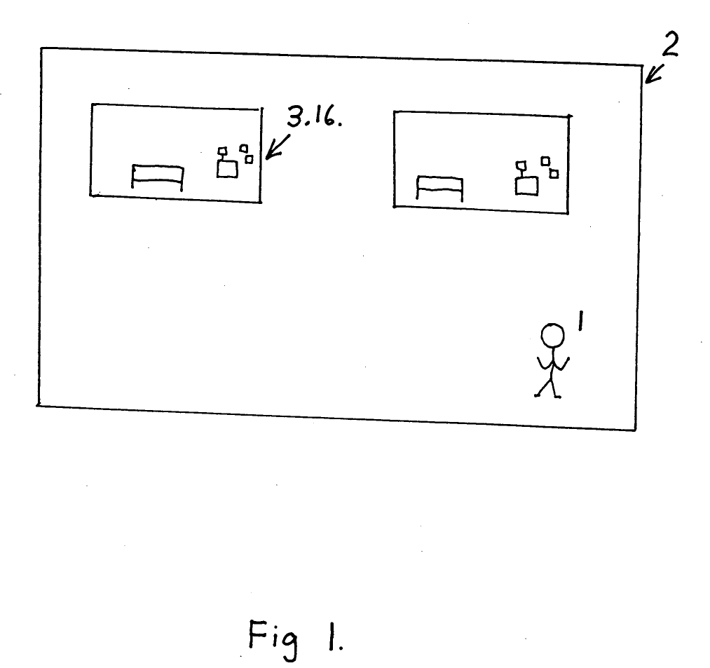

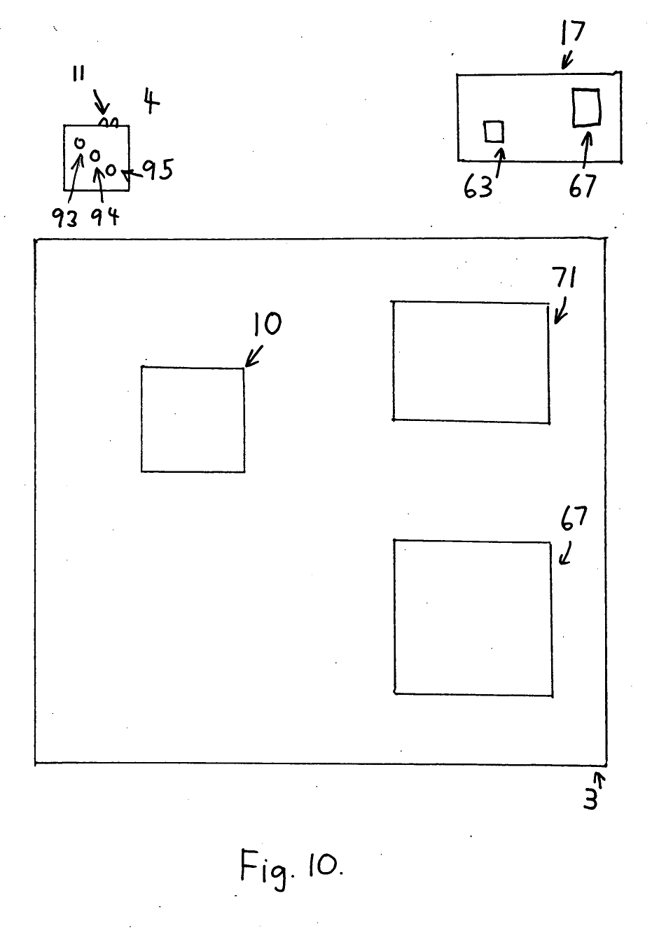

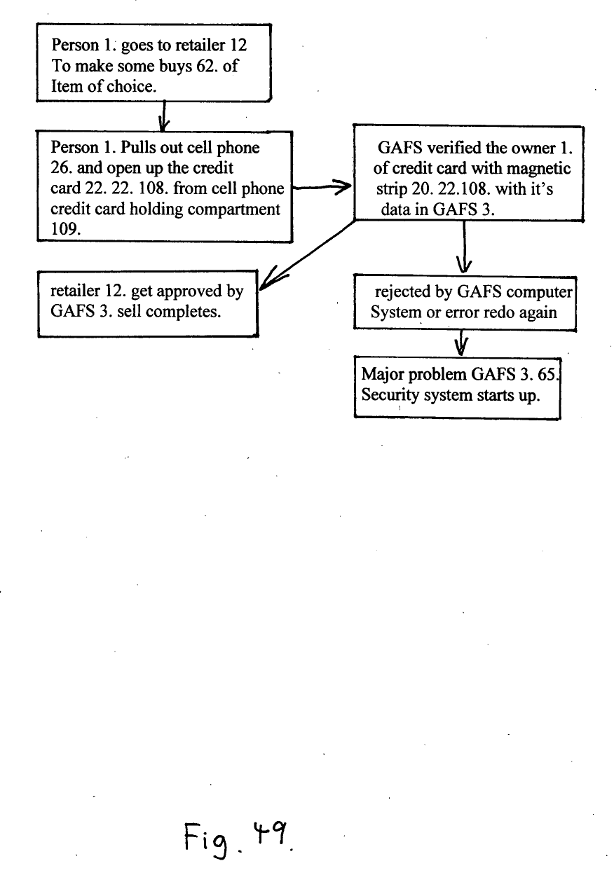

Referring now to the drawings with more specificity, FIG. 1 generally depicts a user as at reference numeral 1 approaching or traveling to a so-called “Global Anti-Fraud System” (GAFS) depot or identification center or governmental agency as at reference numeral 2 for obtaining a GAFS identification unit with smart chip technology. It is contemplated that the GAFS depot 2 preferably comprises certain computer-enhanced mechanisms, systems, or machines as at reference numeral 3 for issuing select personal send receive purchasing units 100 (as generally illustrated and referenced in FIGS. 10, 11, 13, 18-24, 28-31, 40, and 46) embedded with smart chip technology. In other words, FIG. 1 depicts a place to gent an identification device for positive identification under GAFS with a smart chip. It is contemplated that the identification device is defined by the personal send-receive unit 100 and may take the form of a key fob type device, a credit card type device, a cellular telephone type device, or similar other article, and all of which may provide electronic gateways to lines of purchasing power or credit, as governed by a financial establishment 99 or system as generically illustrated and referenced in FIG. 49.

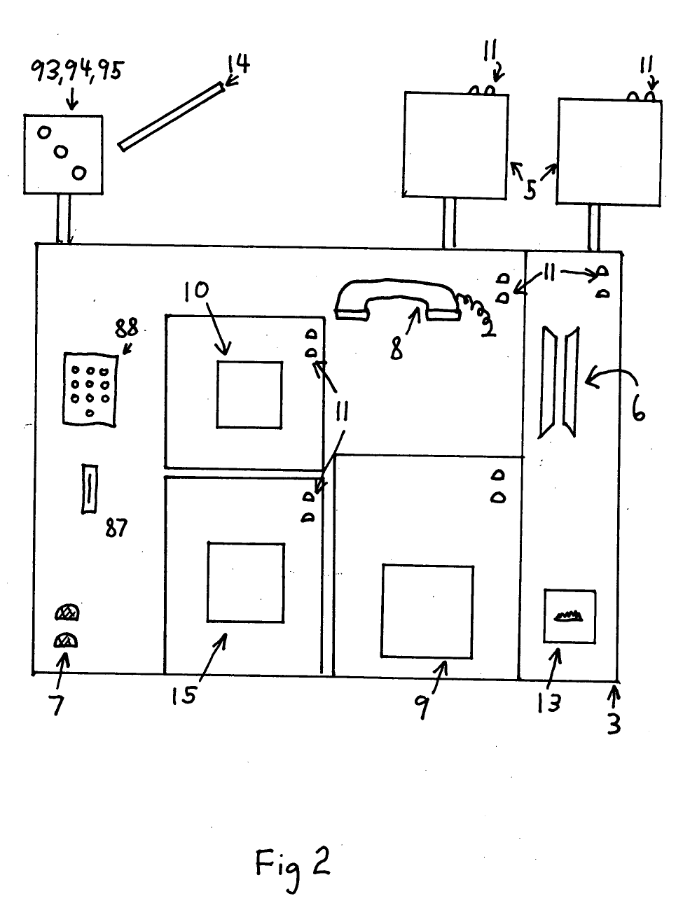

FIG. 2 is a generic depiction of a machine 3 may well function to issue and/or authenticate personal send-receive units 100 located at the GAFS depot (or vendor establishment(s) and the like) otherwise depicted in FIG. 1. The unit-issuing or unit verifying machine 3 depicts various means for inputting and outputting data. In this regard, it may be seen from an inspection of FIG. 2 that machine 3 may preferably comprise a camera as at reference numeral 4; multiple visual output displays as at reference numeral 5; a check reader as at reference numeral 6; a loudspeaker assembly as at reference numeral 7; a telephone handset as at reference numeral 8; a fingerprint reader as at reference numeral 9; a smart chip activator/reader as at reference numeral 10; indicator lights as at reference numeral(s) 11; a receipt output as at reference numeral 13; a visual output display as at reference numeral 14; an implant chip reader as at reference numeral 15; a card insert as at reference numeral 87; and a key pad as at reference numeral 88. It may be readily understood from a consideration of the foregoing that the GAFS machine 3 is a multi-functional machine comprising one or more cameras; one or more visual output displays or television monitors; one or more paper-based note readers; one or more loudspeakers; one or more telephone handsets; one or more fingerprint readers; one or more smart chip readers (for reading chip-embedded credit cards, cellular telephones, identification cards, or anatomically-implanted (i.e. under a user's skin) smart chips).

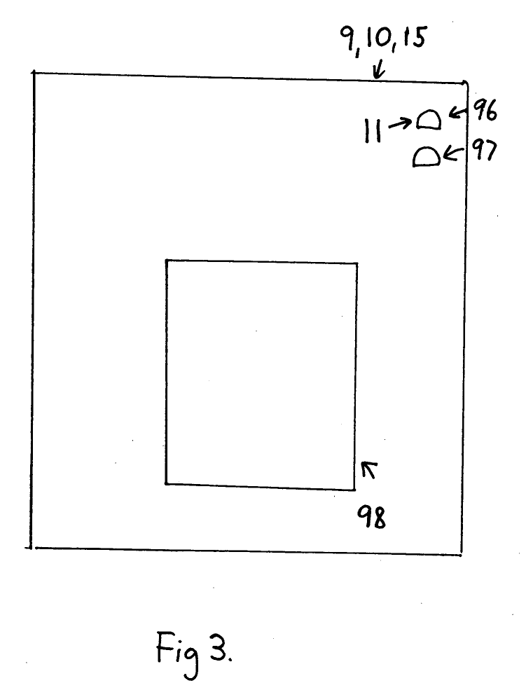

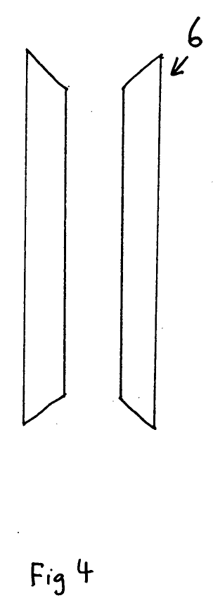

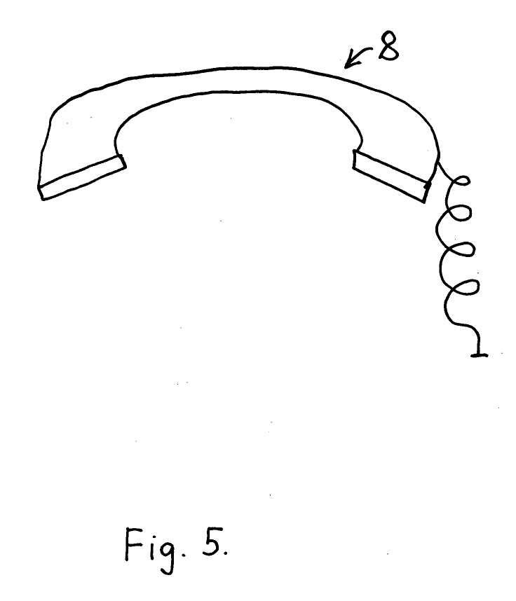

FIG. 3 is a generic black-box type representation of three structures otherwise centrally depicted in FIG. 2, namely the finger print reader device 9, the smart chip reader device 10 (which may be used to read smart chips embedded in identification cards/credit cards/cell phones, etc.; and the implant chip reader device 15. The fingers or devices may be inserted into an aperture as at 98 in FIG. 3, and means housed in the box may be used to scan and or read information from the structure otherwise inserted into aperture 98. FIG. 4 is an enlarged generic representation of one paper-reading device or structure 6 otherwise depicted and referenced in FIG. 2 for reading paper-based transaction materials such as checks, or money orders, or bank notes, or food stamps. FIG. 5 is a generic representation of a telephone handset, which figure is included as symbolic of telephonic communications thereby enabled via the machine 3 otherwise depicted in FIG. 2.

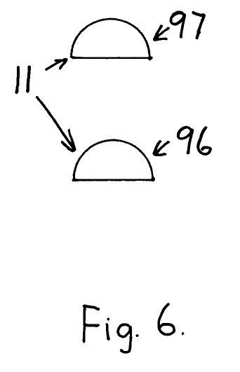

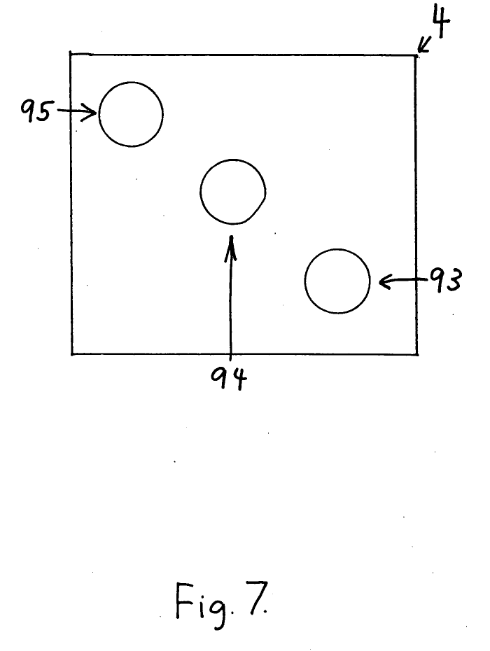

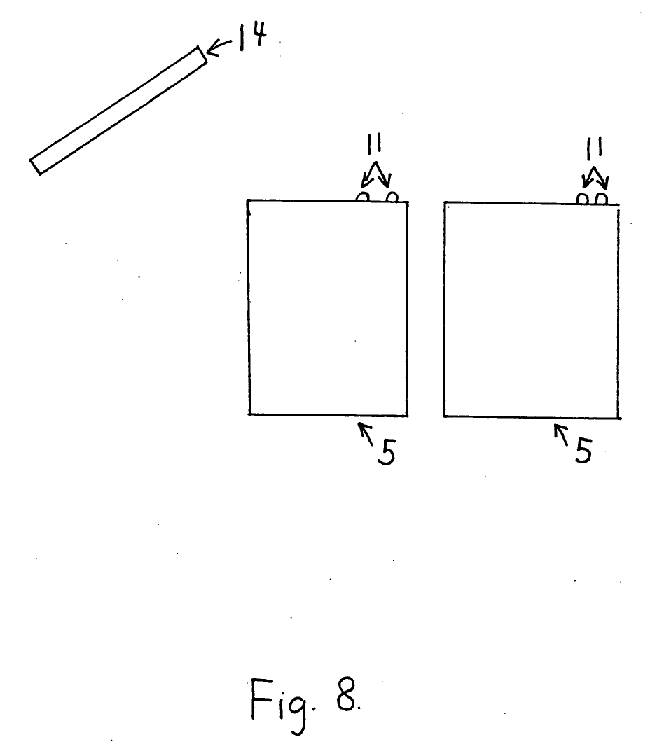

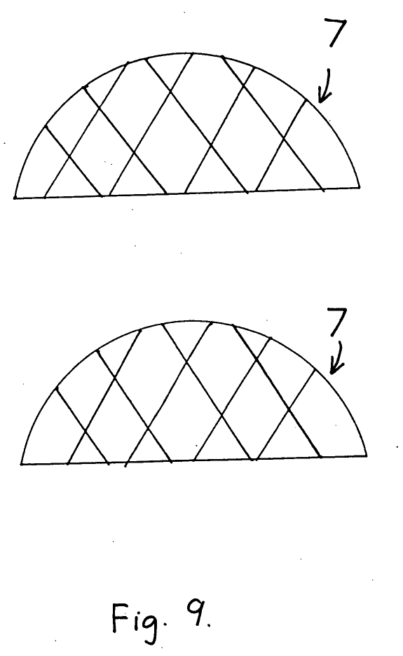

FIG. 6 is an enlarged generic representation of first and second light display devices previously referenced at numeral 11. It is contemplated that the light display devices 11 may well function to provide visual signals for alerting the user 1 to normal operating modes (a green light 97) or error modes (a red light 96). FIG. 7 is an enlarged generic representation of a camera device 4 or system otherwise depicted in FIG. 2, which camera device 4 preferably comprises a plurality of, and preferably three input windows 95, 94, and 93 for receiving (1) visible light wave electromagnetic radiation input as at window 95; (2) infrared wave electromagnetic radiation input as at window 94; and (3) radio wave electromagnetic radiation input as at window 93. FIG. 8 is a generic representation of a system of visual output displays as at 5 and 14. Visual output display 14 is seen from a side type view and visual output displays 5 are depicted from a frontal position. It is contemplated that the displays 5 and 14 may well function to visually display information otherwise made available to the machine 3 by way of the various input means. FIG. 9 is a generic representation of first and second loudspeakers for enabling aural delivery of information.

FIG. 10 is a generic representation of a machine 3 (positioned at the bottom of the figure) for creating or issuing new personal send-receive units 100 such as identification cards. In this regard, it is contemplated that any number of data input means (as previously set forth and) as symbolized by the camera 4 positioned at the upper left of the figure) may well function to receive personal data regarding the user 1 who wished to obtain a new personal send-receive unit 100. This input data can then be encoded into or with the issuing unit 100 as dispensed from the machine 3. The personal send-receive unit 100 may be issued, after processed by the machine 3, as a credit card 17 with one or more smart chip(s) as referenced at 63. It is contemplated that a photograph 67 of the user to whom the unit 100 is issued (via a camera input device 4) may be incorporated into the unit 100 or displayed upon the machine 3 for purposes of visual identification. Further, a smart chip testing device 71 as generically depicted and referenced in the noted figure may be included as a means to immediately check whether the issued unit 100 is operational.

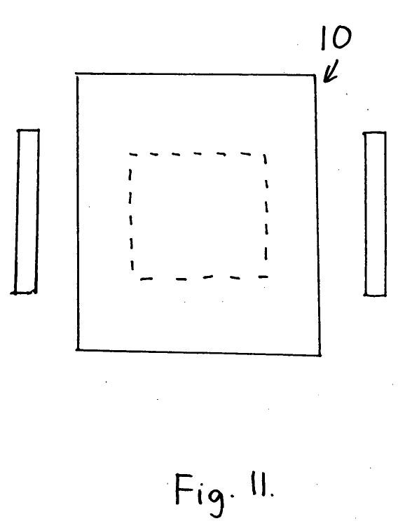

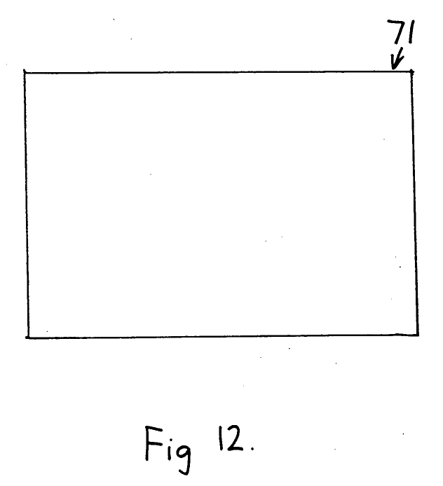

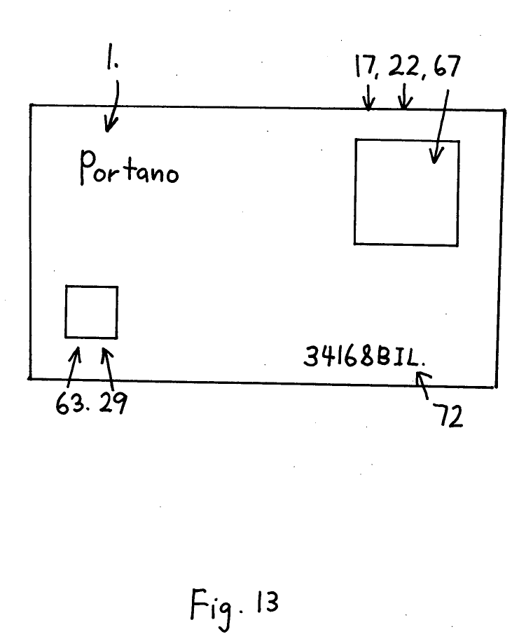

FIG. 11 is an enlarged generic depiction of a smart chip activator/reader device 10 otherwise depicted in FIG. 2. As may be recalled, the smart chip activator/reader device 10 may well function to create, read, and/or activate new identification cards, credit cards, cellular telephones, smart chips, or similar other device and forms part of machine 3. FIG. 12 is an enlarged generic depiction of the smart chip tester 71 otherwise part of the machine 3 for creating new identification cards shown in FIG. 10. FIG. 13 is an enlarged view of a new identification card 17 with smart chip or smart chip technology 29, 63 otherwise shown at the upper right of FIG. 10. It may be seen from an inspection of FIG. 13 that the card 17 may preferably comprise ID identification codes 72.

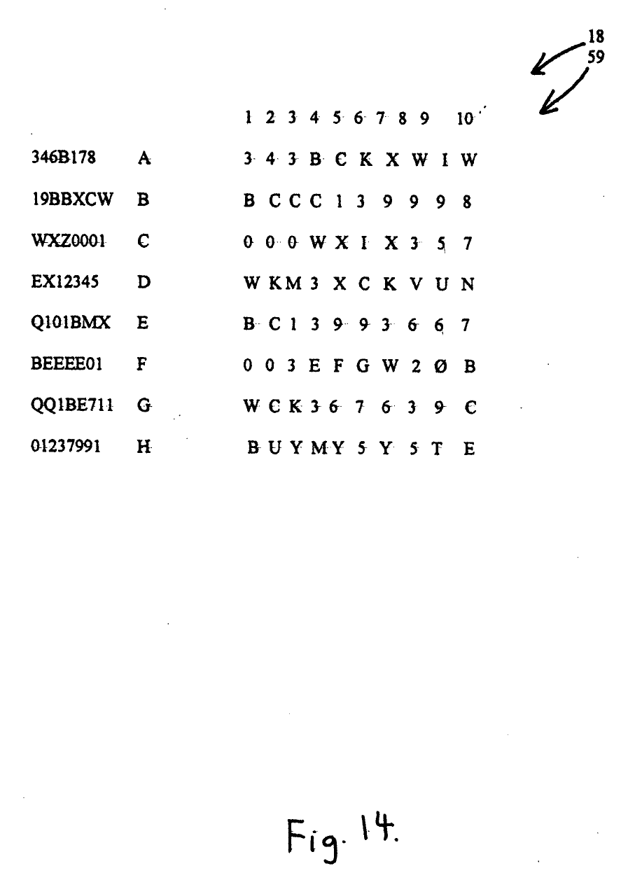

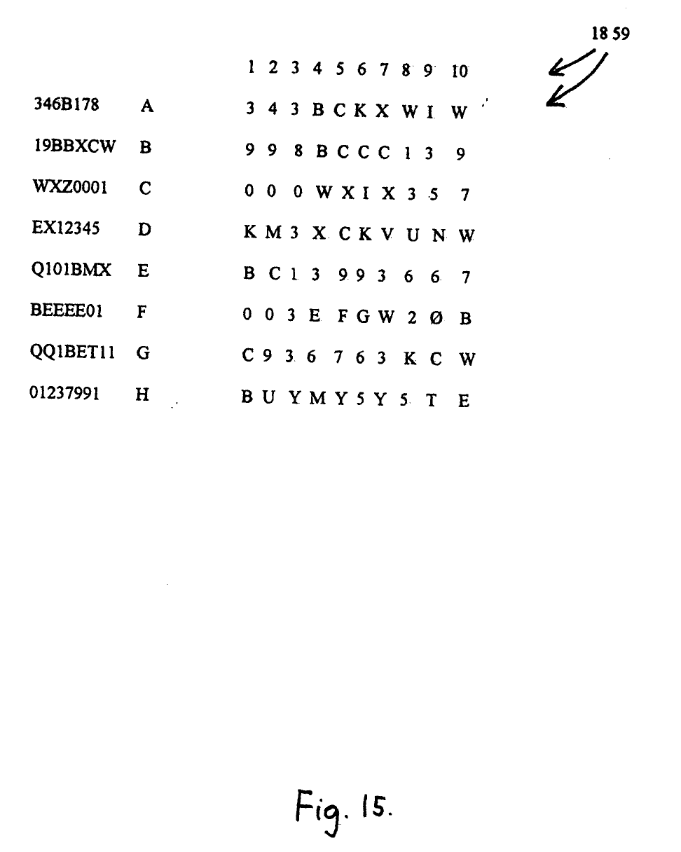

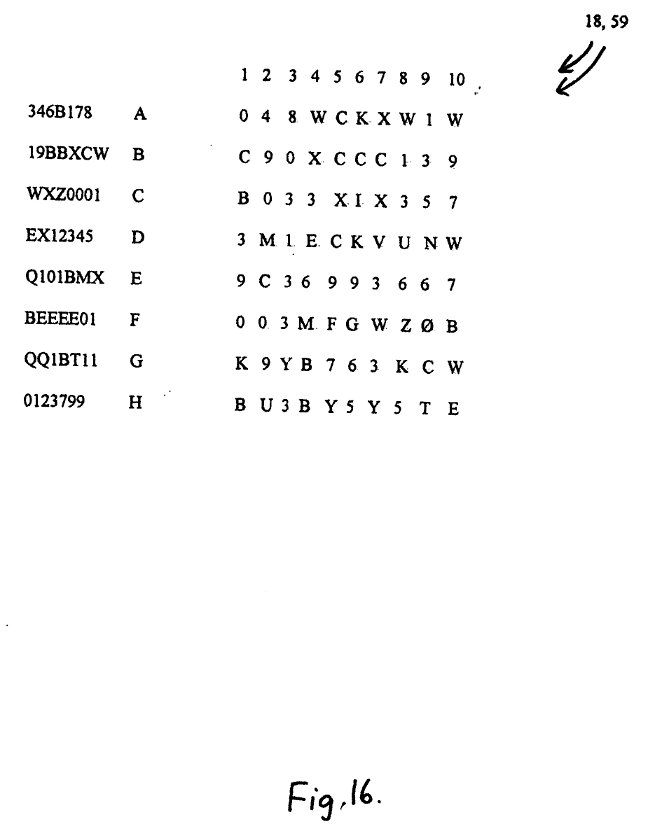

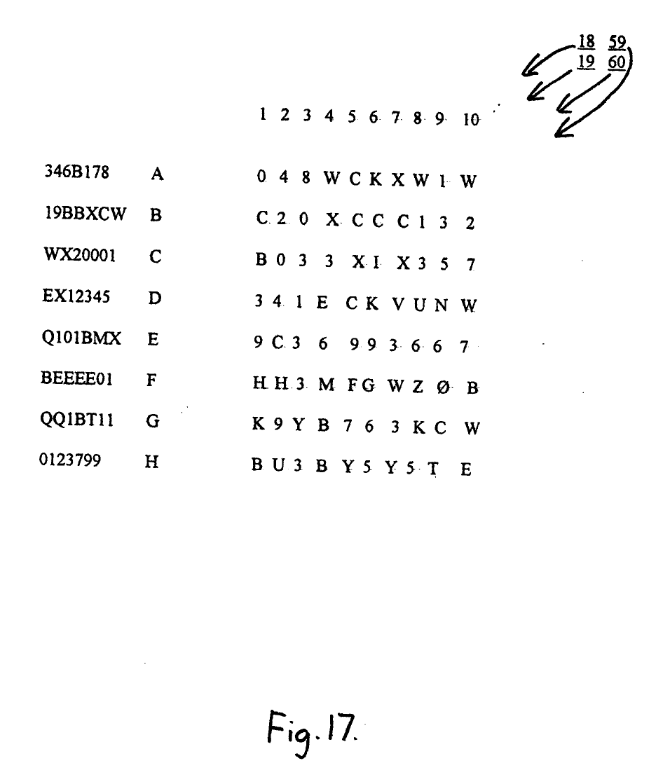

FIG. 14 is a generic first sequence of non-final codes 18 that may be used in the smart chip 29 of the present invention; FIG. 15 is a generic second sequence of non-final codes 18 that may be used in the smart chip 29 of the present invention; FIG. 16 is a generic third sequence of non-final codes 18 that may be used in the smart chip 29 of the present invention; and FIG. 17 is a generic fourth sequence of final codes 19 that may be used in the smart chip 29 of the present invention. From a comparative inspection of FIGS. 14-17, it may be understood how coding may well be incorporated into the design to effect heightened security via the smart chip technology of the present invention.

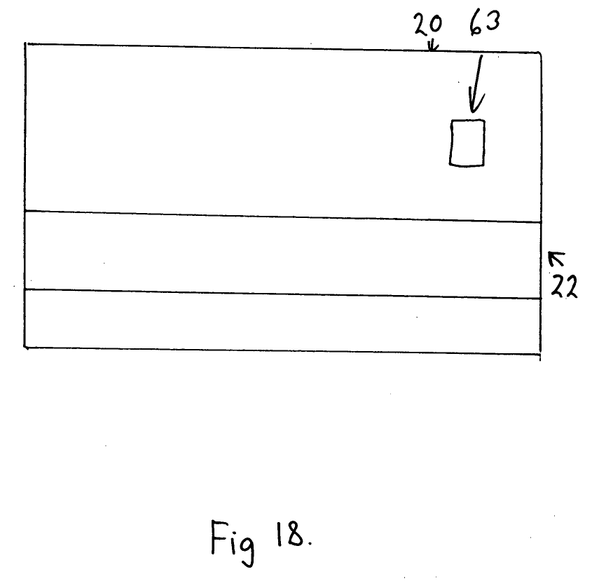

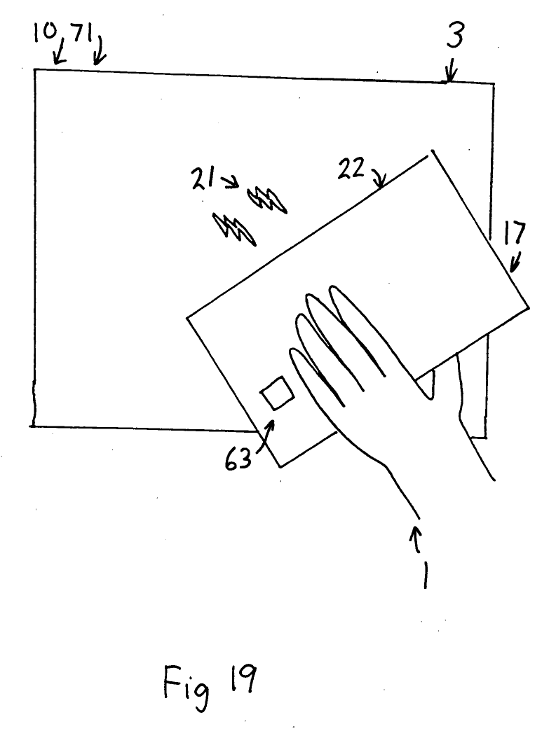

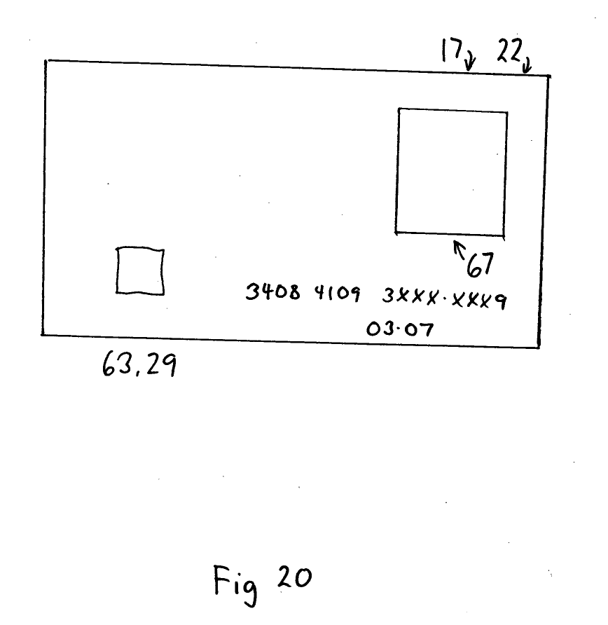

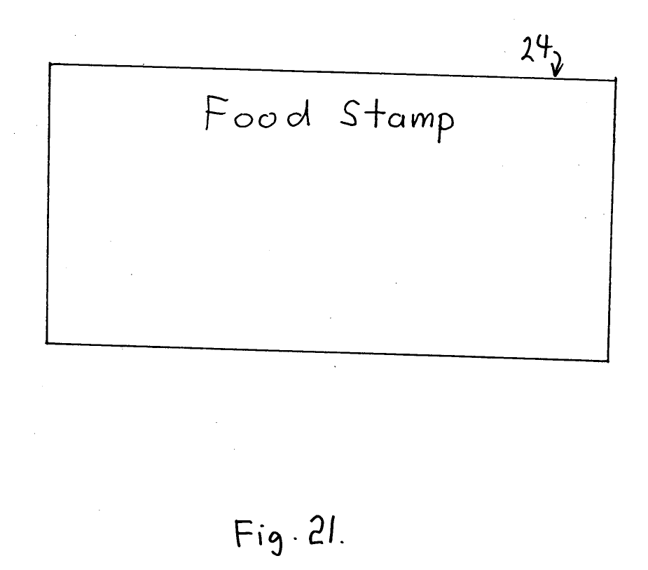

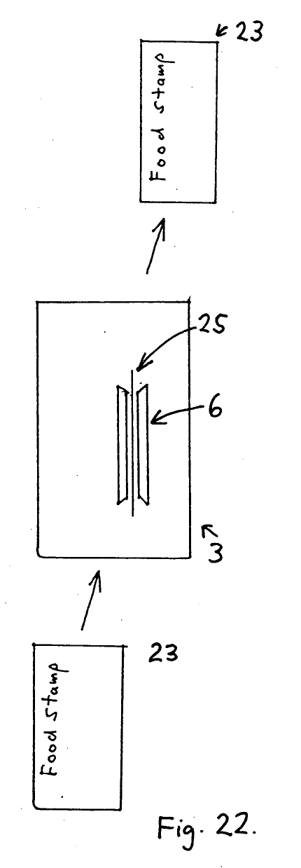

FIG. 18 is a generic depiction of the magnetic strip-bearing back side 20 of a credit card 22 with embedded smart chip 63 to be utilized in combination with the so-called GAFS machine 3 of the present invention. It is contemplated that the credit card 22 shown in FIG. 18 comprises a smart chip having final codes 19. FIG. 19 is a depiction of the credit card 22 otherwise shown in FIG. 18 being read by way of a scanner device FIG. 20 is a generic depiction of an identification card 17 or Medicare card 23 with embedded with a smart chip or smart chip technology 29, 63. FIG. 21 is a generic depiction of a food stamp 24. FIG. 22 is a depiction of the food stamp 23 or 24 otherwise shown in FIG. 21 being swiped through a card reader 6 of the GAFS machine 3. The food stamp 23 or 24 thereby becomes a food stamp being read (as at 25) by the GAFS machine 3. When the person needs to obtain food or medicine or any other programs, he or she may wish to utilize the personal send-receive unit 100. The person 1 uses his or her identification to complete a transaction. It is contemplated that the person may first select the item; carry the item to a cash register to make a purchase; provides the cashier with the selected item; the cashier requests user-identification with smart chip technology; and the cashier places the user-identification (personal send-receive unit 100) adjacent a GAFS computer system or machine 3 to check for positive match of person or to otherwise authenticate the device usage. The GAFS computer or machine 3 may then request a fingerprint from the person or request the person to position themselves in front of camera to effect a positive match of a bona fide user 1. If the user's identification is authenticated via the GAFS computer or machine 3, the sale may be completed. If use of the personal send-receive unit cannot be verified, the sale may be voided and the authorities may be selectively notified if it is suspected that unlawful activity is afoot. Notably, the GAFS computer or system may accept food stamps tickets, if required.

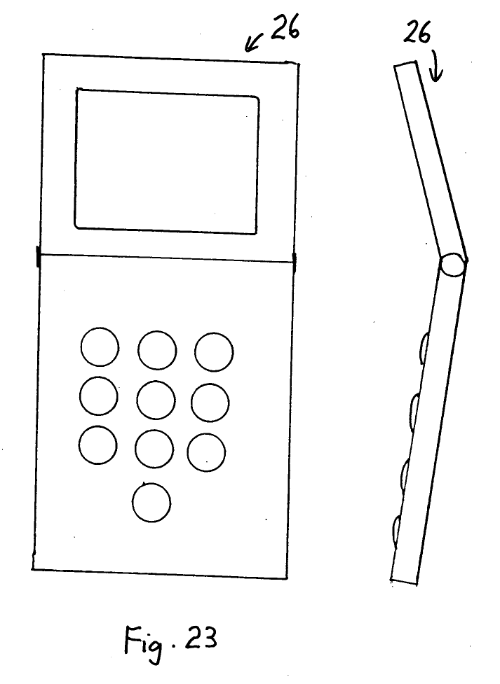

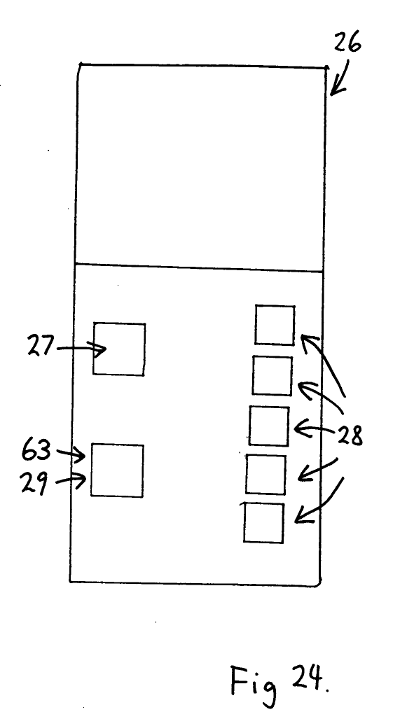

FIG. 23 is a frontal and side view depiction of a generic cellular telephone 26. It is contemplated that cellular telephones such as the generic phone 26 depicted in FIG. 23 may house certain smart chip technology as referenced at 27, 28 in FIG. 24 for converting an otherwise standard cellular telephone into a personal send-receive unit 100 according to the present invention. In other words, FIG. 24 attempts to show multiple smart chips (27, 28) within the cellular telephone 26, certain of which may function as the cellular telephone's identification code and certain of which may function as the GAFS verification chips for enabling GAFS machinery to verify and/or authenticate whether the cellular telephone being presented to a GAFS machine is a verifiable cellular telephone 26.

In other words, the cellular telephone 26 has within it a credit-enabling device and thus functions as a credit card type cellular telephone, which telephone may be used to effect an electronic transaction after the credit-enabling device or cellular telephone is properly activated.

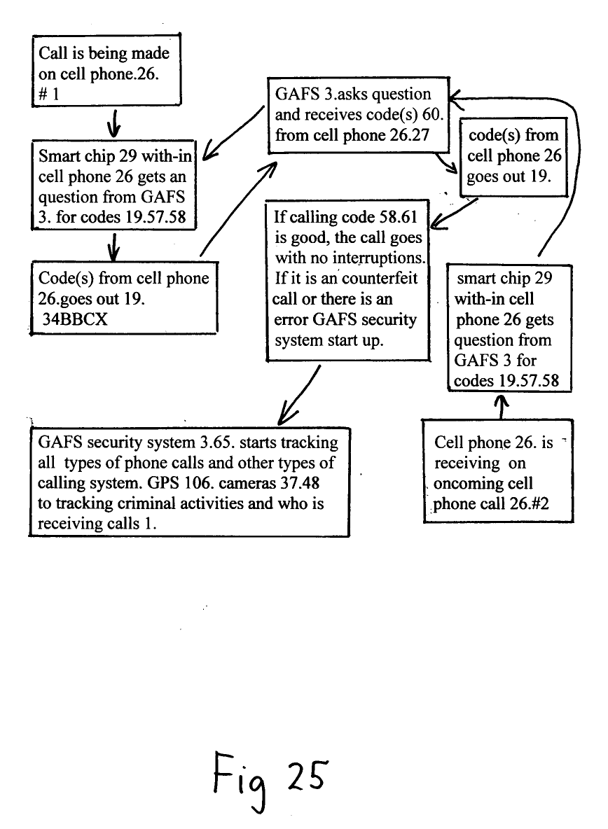

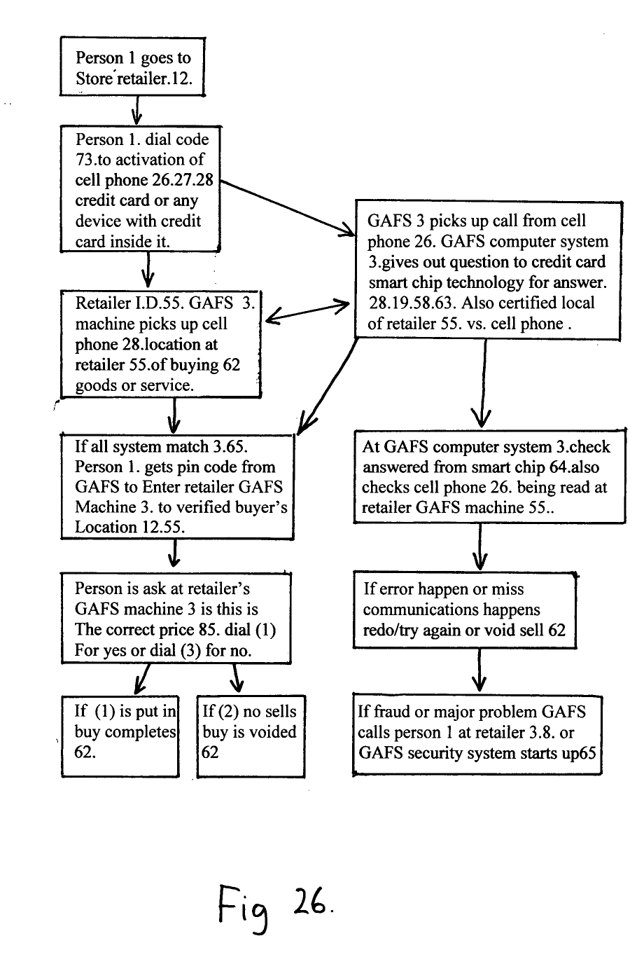

FIG. 25 is a flow chart type diagram showing cellular telephone call(s) being sent and received simultaneously. FIG. 26 is a flow chart type diagram showing certain methodology for effecting a purchase via a cellular telephone 26 at a point of sale or vendor establishment. In this regard, it is contemplated that the smart chip credit card within the cellular telephone starts its process of making the transaction complete. The person or user 1 of the cellular telephone version 26 of the personal send-receive unit enters user-specific codes to start or activate or authenticate the credit card cellular telephone. Activation may occur at the retailer or vendor establishment. At the retailer or vendor establishment 12 the GAFS machine 3 reads the cellular telephone information as a means to access the line of credit enabled thereby. The GAFS machine 3, for example, may pose a security question to the user as a means to elicit authentication from the cellular telephone 26 and open access to the line of credit from the financial system or establishment. The cellular telephone may provide an authenticating answer to the security question in the form of a code, as follows: 3BB1799. The GAFS machine 3 then checks the retailer identification number and codes to determine of the user is properly using the personal send-receive unit and whether the answer codes 19 are authentic. If the codes are authentic, the personal send-receive unit 100 is authenticated and the user 1 is free to utilize the personal send-receive unit 100 in the form of a cellular telephone 26 to effect a valid transaction. If the personal send-receive unit cannot be authenticated, the transaction may be voided in a first instance, and certain authorities may be alerted in a second instance for tracking the personal send-receive unit 100 for apprehension purposes.

To prevent identity theft of cellular telephone or any mobile communicator such as embodied by a personal send-receive unit 100, the cellular telephone 26 houses certain smart chip technology. The smart chip is an added security device inside the mobile communicator. This smart chip works with the cellular telephone's call-enabling circuitry, and provides a code of security when the cell phone user makes a call and receives calls. When a person makes a call out, the cell phone company gives a code message to the cell phone, which code may appear, as follows: 3BC491. The cell phone 26 smart chip may then provide an answer, as follows: 99MX3C. Notably, the person who is making the call does nothing. This is for checking the cell phone and whether the cell phone operation is bona fide or counterfeit. If the cell phone 26 has a positive identification makes the call go through. But if a fake cell phone comes in the call can be cut off. The phone company can keep the call going to see what the person has to say what other numbers are being called and check who the other callers are. This is to check for unlawful activity. Under GASF processes, the callers and receivers may be plotted out to see where their location is.

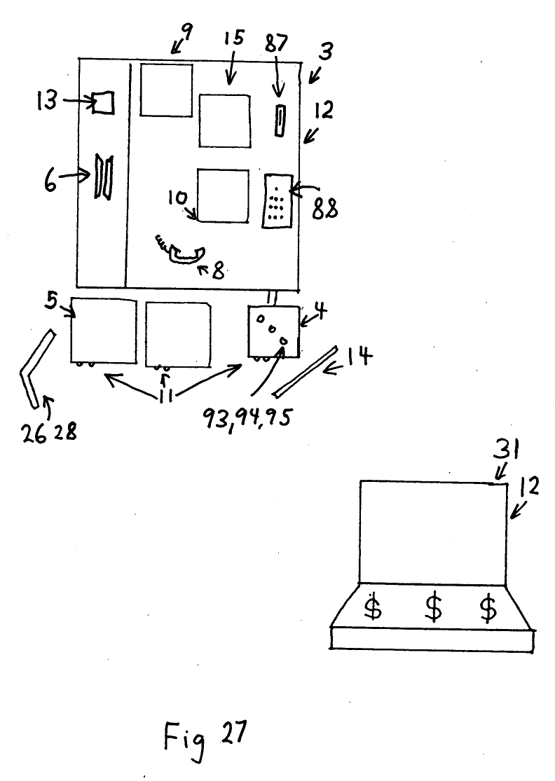

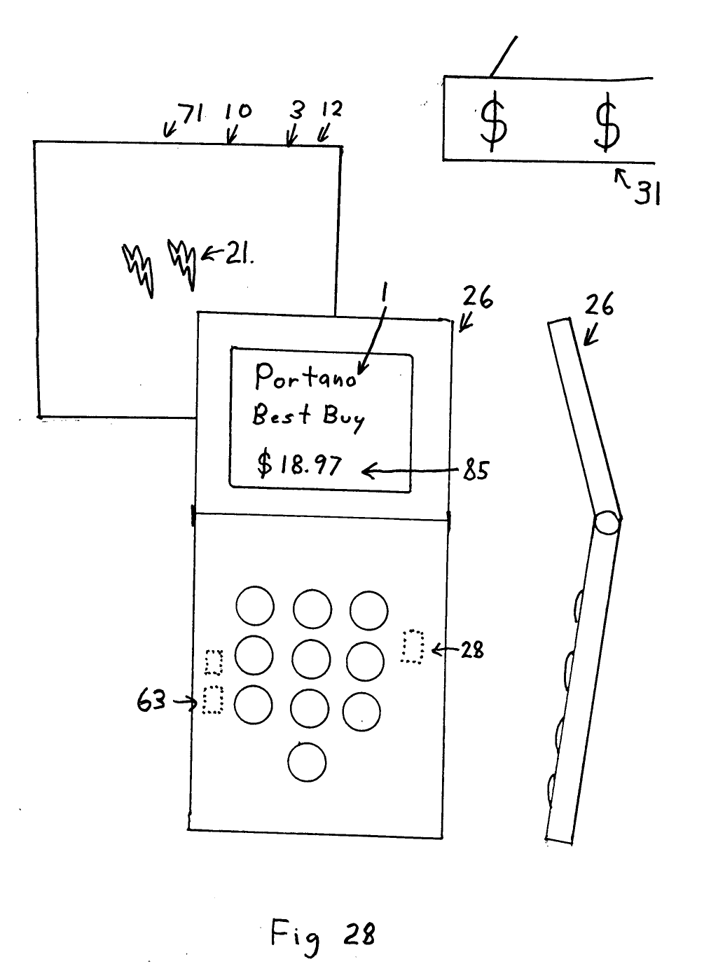

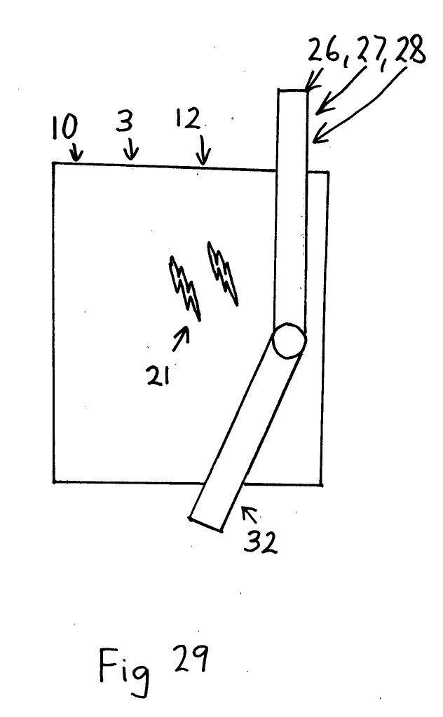

FIG. 27 is a generic depiction of a cash register 31 at a retail outlet or vendor establishment 12. FIG. 28 is a cellular telephone 26 according to the present invention being used as a credit device or personal send-receive unit 100. As generally depicted in FIG. 28, the cellular telephone 26 is being presented to a retailer-based GAFS machine 3 at which time certain retail identification(s) are compared against the physical location of the cellular telephone 26. Notably, the GAFS machine 3 is wirelessly reading coded information from the cellular telephone 26. FIG. 29 is an enlarged depiction of the GAFS machine 3 being used to wirelessly (as at reference numeral 21) read coded information from the cellular telephone 26.

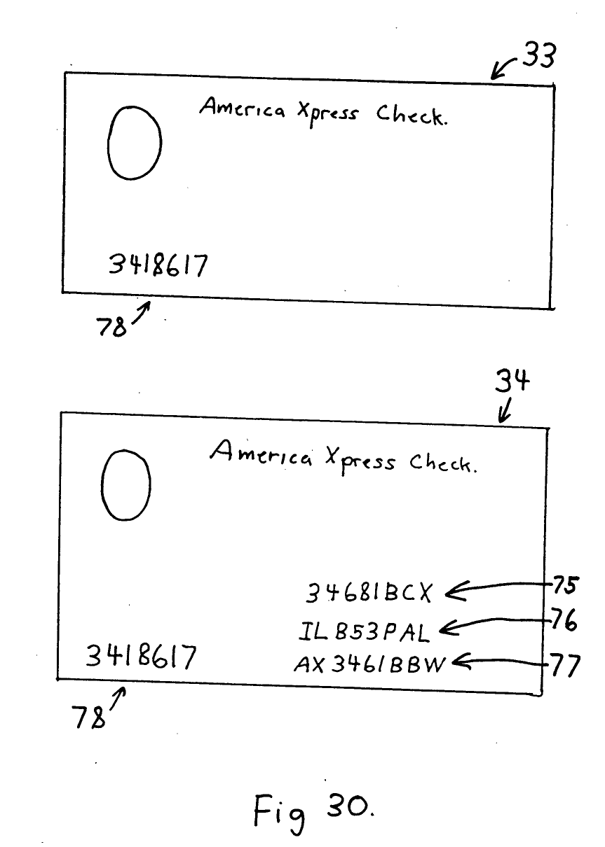

FIG. 30 is a generic depiction of a money order travel check or bank check note showing the chip/code-embedded paper before (top) coding as referenced at 33 and after (bottom) coding as referenced at 34. It may be seen from an inspection of the noted figure, that before element 33 and after element 34 both comprise a check or money order identification number as at reference numeral 78. After coding, the after element 34 preferably comprises a bank's or financial establishment's coding as at reference numeral 75; certain GAFS coding as at reference numeral 76; and certain third party coding as at reference numeral 77. In this regard, it is contemplated that money orders, traveler's checks, and bank checks may preferably comprise written codes as provided by way of GAFS. It is contemplated that the bank or similar other financial establishment will place coding on the notes.

To this end, it is further contemplated that a teller at a bank of financial establishment can place a check into a machine 3 to be read for check numbers. The teller will start up the computer system or machine 3 to start coding the checks 33. The bank or place of sale gives its codes 75 written on the checks. GAFS machining 3 will place its codes 76 on the check(s). If a different company or third party such as American Express wishes to place proprietary coding (as at 77) on the notes, the third party may do so and the notes may well resemble American Express Traveler's checks. Then American Express will place its code(s) 77 on the checks. After all of the codes are typed on the checks by the computer system or machine 3 the teller hands the checks out to the buyer.

To cash out the coded paper notes, the person or user 1 who receives the checks 34 goes to any place to cash them out for goods and services. The person or user 1 hands over the checks 34 to the retailer or vendor establishment 12 having a GAFS machine 3. The retailer 12 may then place the money order 34 into the computer system of GAFS machinery 3. The machine 3 may then reads the check identification number 78 and calls up the bank, GAFS and if needed, the third party codes 75, 76, and/or 77, example: American Express. In other words, GAFS machine 3 will check its own codes on the check 34; the bank checks its own code 75; and if needed, a third party checks its code 77 with the check identification number 78. The computer system GAFS 3 will get confirmation from all three. If all three gives the OK, then the sale is approved and may be finalized. If any funds are left over from the funding account, the person 1 may receive cash or credit of leftover funds.

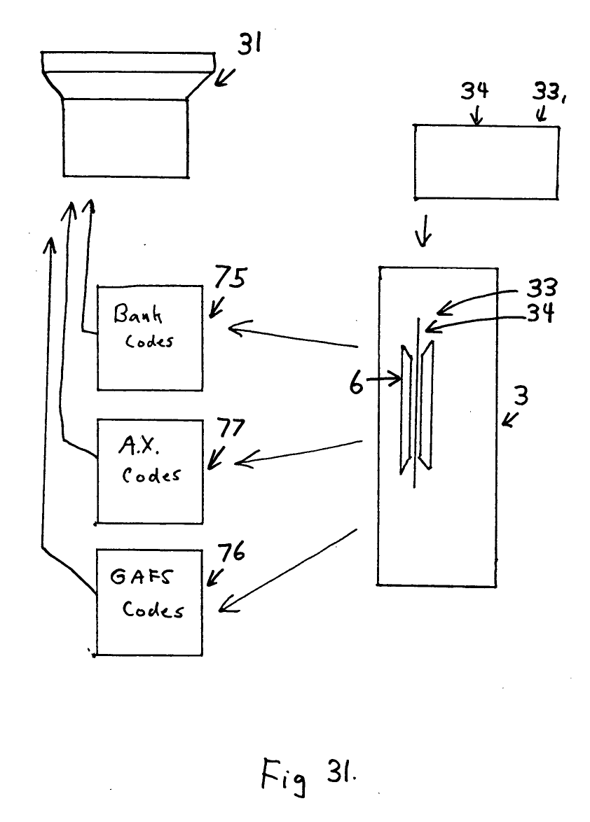

FIG. 31 is a hybrid/schematic flow chart type depiction of the note otherwise depicted in FIG. 30 being swiped at a point of sale swipe device, which device communicates (e.g. telephonically as at reference numeral 36) with a bank, a GAFS machine, and/or a third party creditor. Reading on check the machine is talking to three different areas to get 3 codes back from the bank, AMEX and GAFS the register is waiting for an OK from all three to make sure this is real.

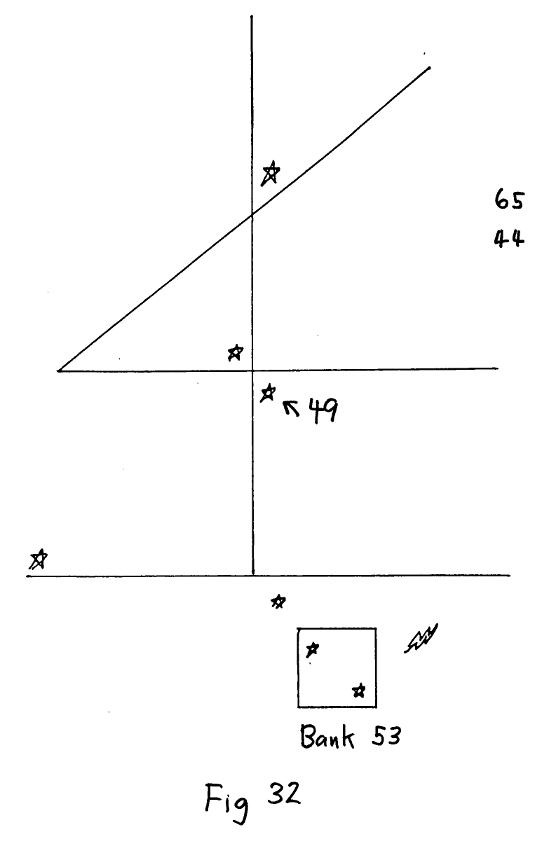

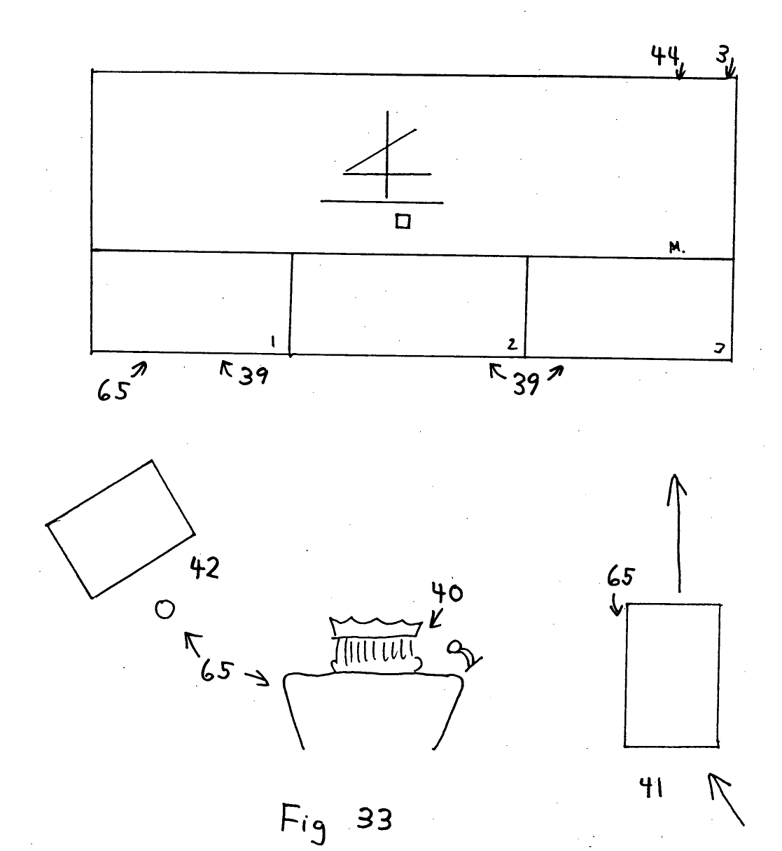

It is contemplated that certain GAFS security measures may be implemented when the person 1 is trying to use the fake ID's, fake credit cards, fake money orders at any GAFS location machines 3. When there is fraud detection, a tracking system (as at reference numeral 65 in FIGS. 32, 36, and 37) is activated. It is contemplated that when the tracking system 65 is activated, the fraud detection may be further reported to the police station (as at reference numeral 38 in FIGS. 33-36, 38, and 39) and other parties of interest. It is contemplated that the real-time location of the person carrying an ill-authenticated personal send-receive unit 100 may be tracked via certain means for globally tracking the personal send-receive unit, which means may comprise a series of road-side cameras or road-side surveillance systems for capturing bird's eye visual information on a user carrying the ill-authenticated personal send-receive unit 100.

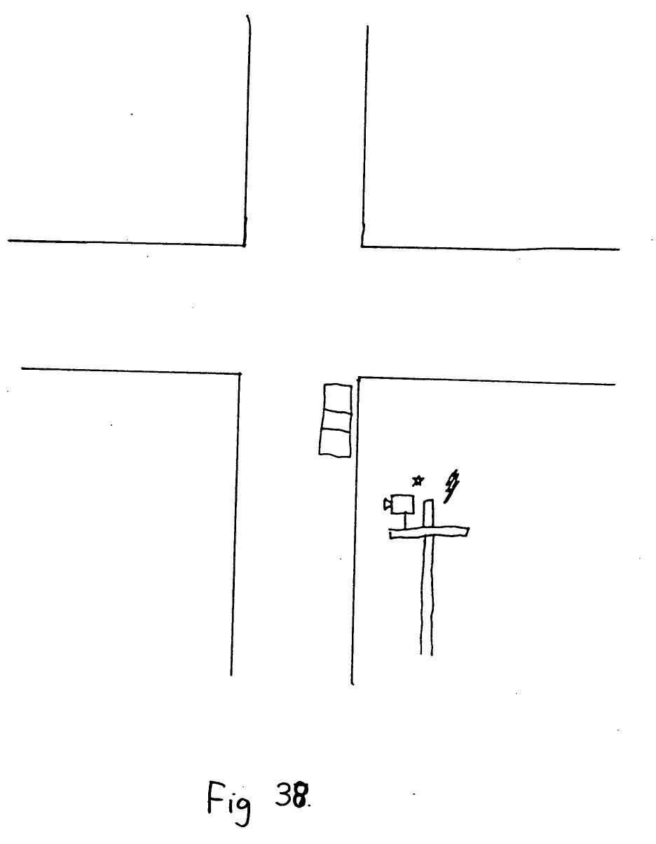

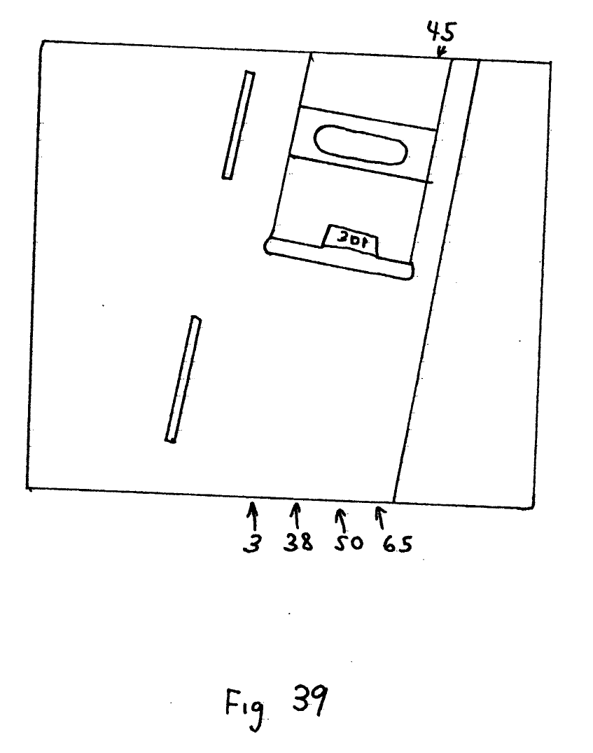

In this last regard, it is contemplated that the unlawful transactor may be tracked in real-time by vendor establishment cameras or bank establishment cameras as generically referenced at 37 in FIGS. 38-39) as well as road-side mounted cameras as at reference numeral 49 in FIGS. 32, 35, 37, and 38). The reader is thus directed to FIG. 32, which is a generic representation of a map in real time showing the location of a detected fraud in progress. The real-time map representation may be effected by way of a global positioning system or a global navigation satellite system, which system necessarily comprises a space segment, a control segment, and a user segment.

On-line Wikipedia resources suggest that the space segment comprises orbiting GPS satellites. The GPS design calls for 24 Earth-orbiting satellites to be distributed equally among six circular orbital planes. The orbital planes are centered on the Earth, not rotating with respect to the distant stars. The six planes have approximately 55° inclination (tilt relative to Earth's equator) and are separated by 60° right ascension of the ascending node (angle along the equator from a reference point to the orbit's intersection). Orbiting at an altitude of approximately 20,200 kilometers, each satellite makes two complete orbits each sidereal day, so it passes over the same location on Earth once each day. The orbits are arranged so that at least six satellites are always within line of sight from almost anywhere on Earth.

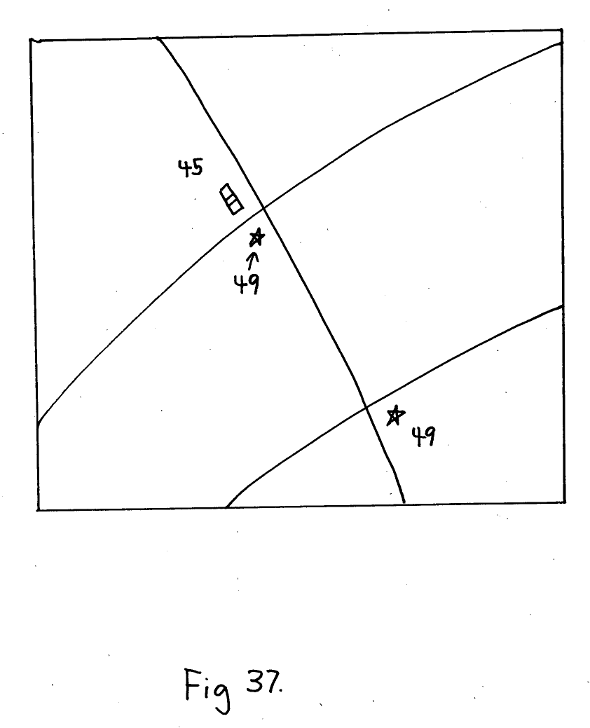

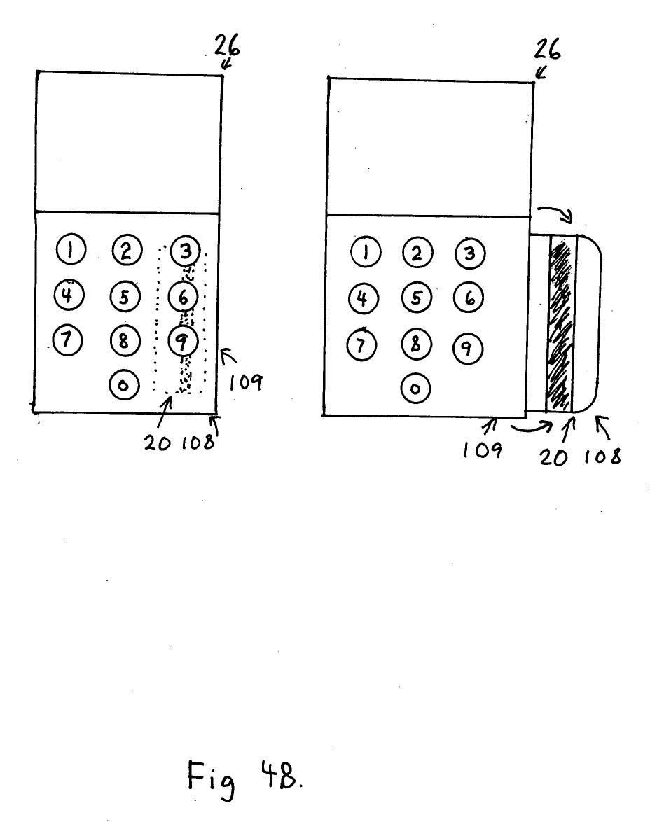

As of April 2007, there are 30 actively broadcasting satellites in the GPS constellation. The additional satellites improve the precision of GPS receiver calculations by providing redundant measurements. With the increased number of satellites, the constellation was changed to a non-uniform arrangement. Such an arrangement was shown to improve reliability and availability of the system, relative to a uniform system, when multiple satellites fail. It will thus be seen that the space segment preferably comprises at least three Earth-orbiting satellites 92 as generally illustrated and referenced in FIG. 48. It is contemplated that at least three Earth-orbiting satellites may well function to enable trilateration by the personal send-receive unit 100 as generally and comparatively depicted in FIGS. 37, 37(a), and 37(b).

A global positioning system (GPS) receiver made integral with the personal send-receive unit may thus calculate its position by measuring the distance between itself and three or more GPS satellites 92. Measuring the time delay between transmission and reception of each GPS radio signal gives the distance to each satellite, since the signal travels at a known speed. The signals also carry information about the satellites' location. By determining the position of, and distance to, at least three satellites, the receiver can compute its position using trilateration generally depicted at 91 in FIGS. 37(a) and 37(b). Receivers typically do not have perfectly accurate clocks and therefore clock error may be periodically corrected in order to enhance real-time tracking capability.

It is noted that trilateration is a method of determining the relative positions of objects using the geometry of triangles in a similar fashion as triangulation. Unlike triangulation, which uses angle measurements (together with at least one known distance) to calculate the subject's location, trilateration uses the known locations of two or more reference points, and the measured distance between the subject and each reference point. To accurately and uniquely determine the relative location of a point on a 2D plane using trilateration alone, generally at least 3 reference points are needed. Referencing FIG. 37(a), point X, a user may want to know his or her location relative to the reference points C1, C2, and C3 on a 2D plane. Measuring a first radius narrows the user's position down to a first circle. Next, measuring a second radius narrows the user's position down to two points, X and Y. A third measurement, namely radius 3, yields the user's coordinates at X. A fourth measurement could also be made to reduce error.

More particularly, a so-called “pseudo-range” is a first-approximation measurement for the distance between a satellite and a navigation satellite receiver—for instance GPS receiver or personal send-receive unit 100 according to the present invention. To determine its position, a satellite navigation receiver will determine the ranges to (at least) three satellites as well as their positions at time of transmitting. Knowing the satellites' orbital parameters, these positions can be calculated for any point in time. The pseudoranges are then the time the signal has taken from there to the receiver, multiplied by the speed of light.

To measure this time, the relationship between the internal receiver time (typically derived from an inexpensive quartz oscillator) and GPS time must be known. This is done by introducing the receiver clock offset or change in time (Δt) into the positional computation, requiring one extra satellite signal. With four signals, solutions for the receiver's position along the x-, y-, z- and Δt-axes can be computed. The reason the term “pseudo-range” is utilized rather than “range”, is precisely this “contamination” with unknown receiver clock offset. Noting that GPS positioning is sometimes referred to as trilateration, it should perhaps be noted that but would be more accurately referred to as pseudo-trilateration. Following the laws of error propagation, neither the receiver position nor the clock offset are computed exactly, but rather estimated through a least squares adjustment procedure as generally depicted in FIG. 37(b).

The control segment of the Global Positioning System governs the flight paths of the satellites and may be defined by US Air Force monitoring stations in Hawaii, Kwajalein, Ascension Island, Diego Garcia, and Colorado Springs, Colo., along with monitor stations operated by the National Geospatial-Intelligence Agency (NGA). The tracking information is sent to the Air Force Space Command's master control station at Schriever Air Force Base, Colorado Springs, Colo., which is operated by the 2d Space Operations Squadron (2 SOPS) of the United States Air Force (USAF). 2 SOPS contacts each GPS satellite regularly with a navigational update (using the ground antennas at Ascension Island, Diego Garcia, Kwajalein, and Colorado Springs). These updates synchronize the atomic clocks on board the satellites to within one microsecond and adjust the ephemeris of each satellite's internal orbital model. The control segment of a global positioning system essentially functions to govern the clock time and the orbital paths of the Earth-orbiting satellites 92.

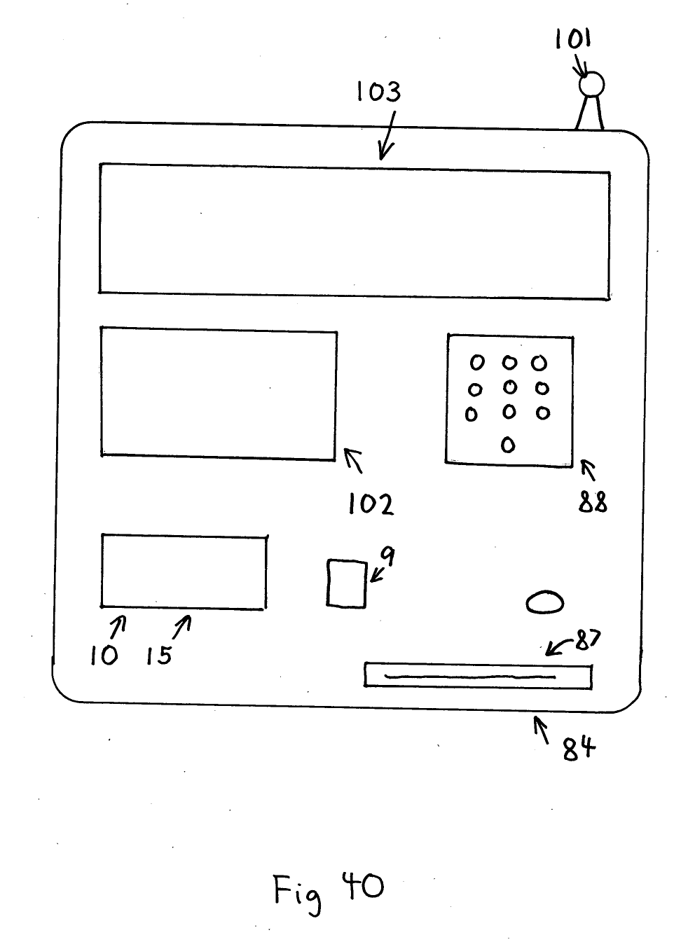

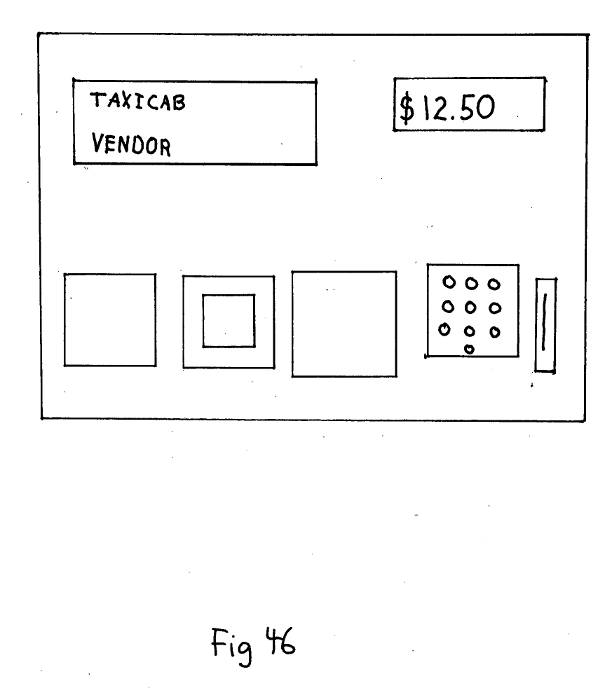

GPS receivers come in a variety of formats, from devices integrated into cars, phones, and watches, to dedicated devices such as those shown here from manufacturers and essentially defined the user segment of the GPS system. In general, GPS receivers may preferably comprise an antenna 101 as generally illustrated and referenced in FIGS. 40 and 46, which antenna is tuned to the frequencies transmitted by the satellites 92, receiver-processors, and a highly-stable clock (often a crystal oscillator) housed within the receiver or personal send-receive unit 100. They may also include a visual display as at 102 in FIGS. 40 and 46 or providing velocity (location and speed) information to the user 1.

The user segment is thus essentially defined by the personal send-receive unit 100. It is contemplated that the global navigation satellite system according to the present invention may well function to determine the real-time global location and velocity (speed and direction) of the personal send-receive unit 100. As noted, FIG. 33 is a generic representation of a police or GAFS command center in which all global tracking information and camera information is being received as a means to enhance apprehension of the unlawful transactor. From an inspection of FIG. 33, it may be seen that an official 40 may be seated and outfitted with a headset or microphone 43 with which to effectively communicate through certain black box type command center hub as at reference numeral 41. The visual or GPS tracking information may be logged and rewound as needed as at reference numeral 42.

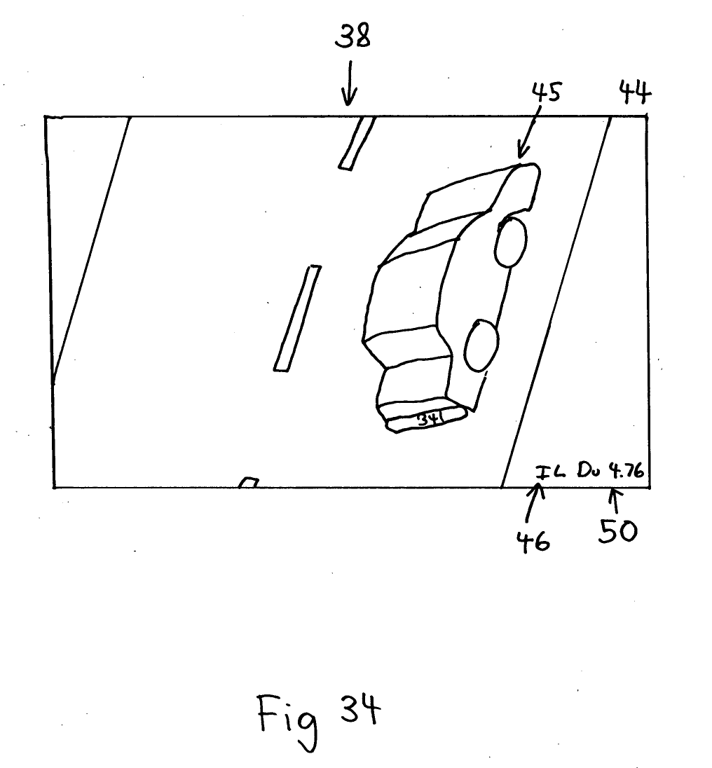

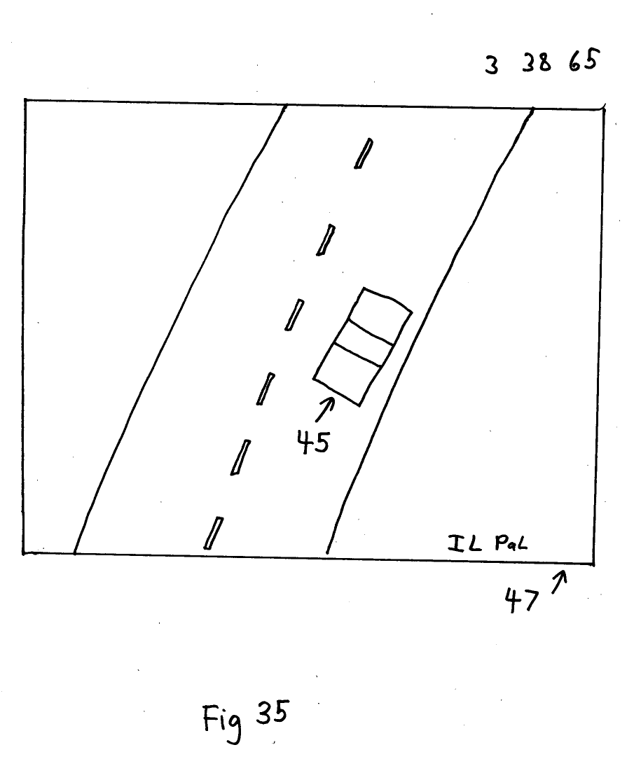

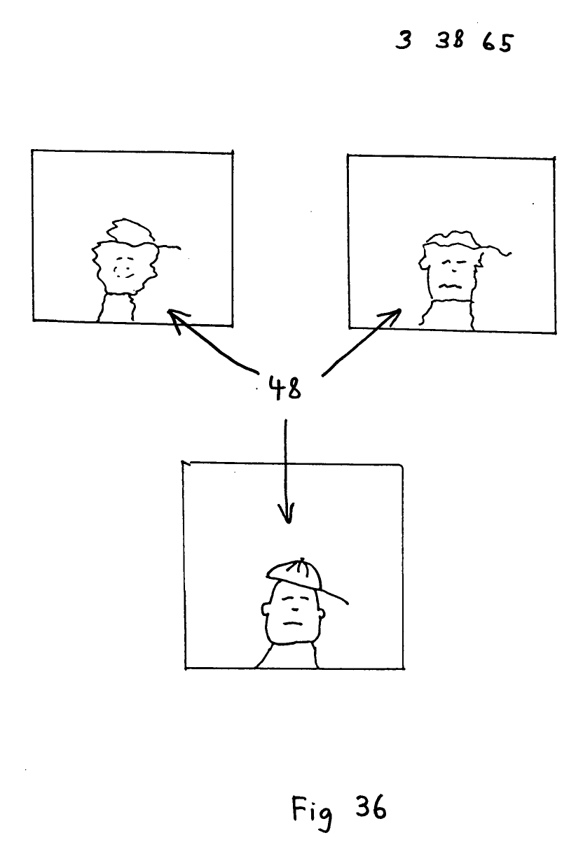

FIG. 34 is a representation of the unlawful transactor traveling in a vehicle 45, which vehicle can be tracked via cameras 37/49 mounted in the vicinity of the unlawful transaction and via global tracking of the unlawfully utilized personal send-receive unit 100 (cellular telephone, credit card, etc.) fraudulently used by the unlawful transactor. FIG. 35 is a computer simulation of the vehicle otherwise depicted in FIG. 34 on a virtual map 44 or 47, which map(s) 44 and 47 can be used to track the vehicular-borne (as at 45) unlawful transactor. FIG. 36 is a sequential depiction of visual displays depicting the GAFS machine 3 defuzzing photos of a person 1 for positive identification. FIG. 37 is a representation of a map 47 showing the location of a vehicular-borne (as at 45) cellular telephone (26) being fraudulently used. FIG. 38 is a bird's eye view vehicle 45 approaching an intersection, which intersection is outfitted with video camera hardware 49 for capturing vehicular information such as license plate information as further generally depicted in FIG. 39. FIG. 40 is a depiction of a proprietary and exemplary personal send-receive unit 100 specifically designed (as opposed to modifying state of the art transaction means) for use in combination with the inventive concepts set forth in this specification.

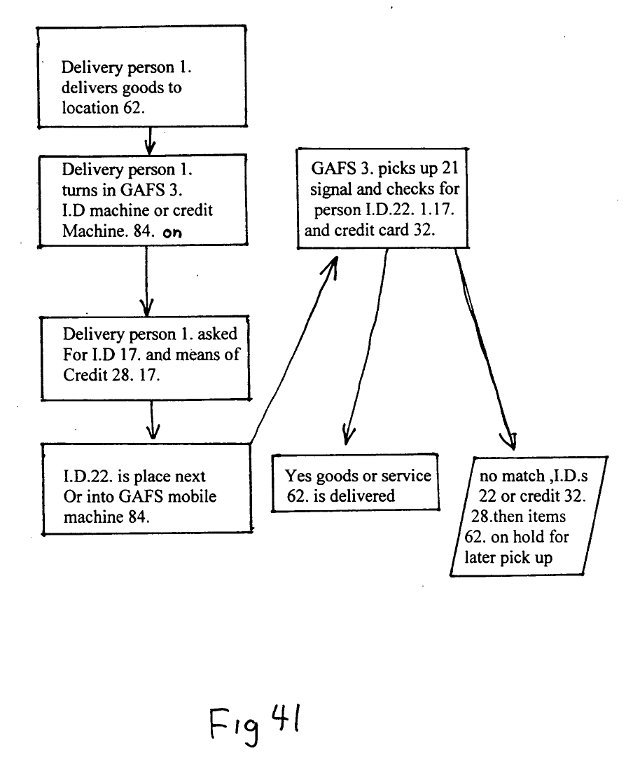

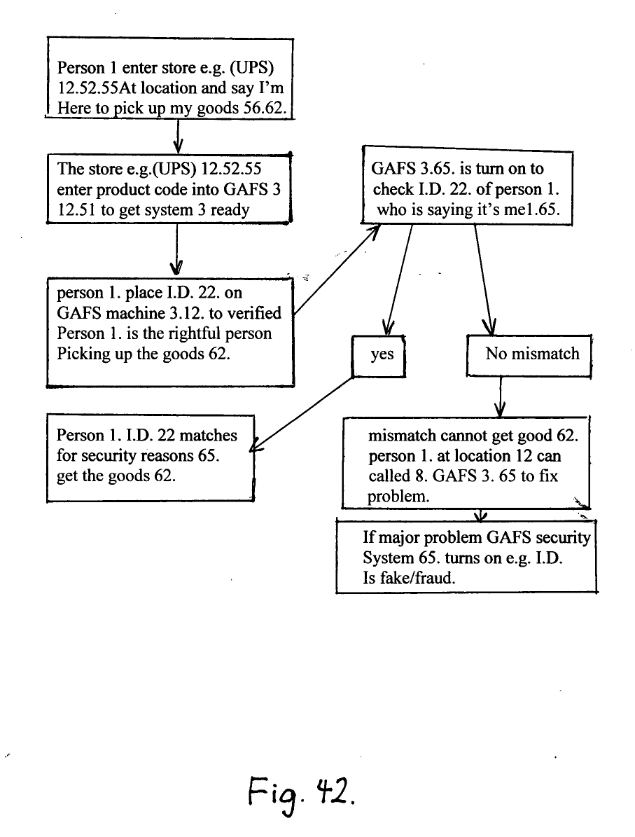

FIG. 41 is a flow chart type depiction of item delivery in authenticated versus non-authenticated scenarios. When a package is delivered of value or by the instruction of the buyer or seller, the delivery person asks for GAFS identification means. A mobile verification device may well function to read authenticating information from the GAFS identification to check whether an authenticated user 1 (or whether an unlawful transactor) is getting the goods or services. When the delivery service goes to location and asks for identification to verify proper delivery, the hand held ID machine or device receives a GAFS type identification only; not a credit card machine. The delivery person places the identification of the user 1 next to the machine and the machine calls or otherwise communicates with the GAFS machine 3 to get an identification match. If a match cannot be made, it is contemplated that the delivery person will ask may have an opportunity to verify if use of the GAFS identification is proper (i.e. if the bona fide user authorized a temporary user to make a transaction through the bona fide user's personal send-receive unit 100. If the delivery person is satisfied that a fraud is not being committed, the GAFS security system and methodology can be restricted from use. FIG. 42 is a flow chart depiction of item pick up in authenticated versus non-authenticated scenarios, which flow chart may be compared to the procedures set forth in FIG. 1 for on-site parcel pick-up.

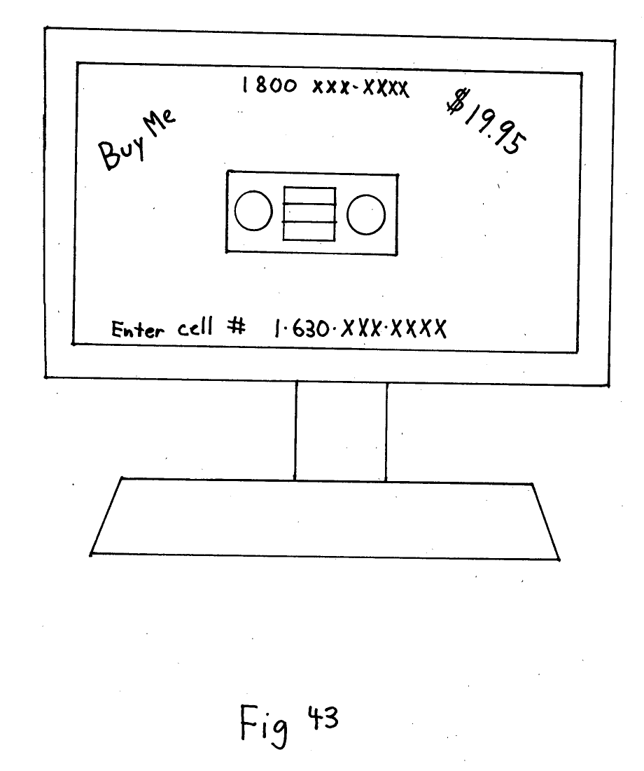

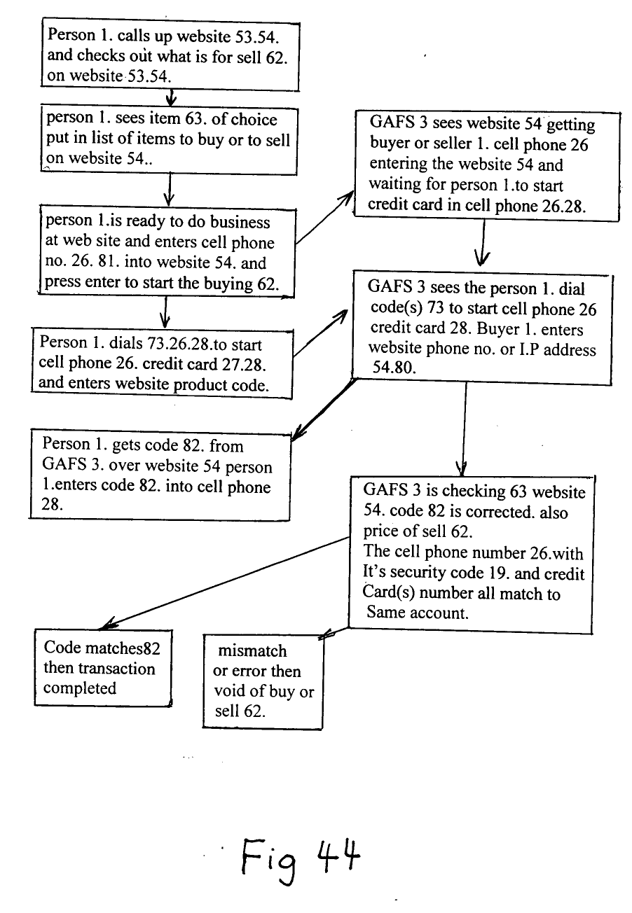

FIG. 43 is a computer monitor type visual display 103 showing items available for purchase and attempts to demonstrate the porthole through which a user 1 may purchase goods/services through the Internet. Further, FIG. 44 is a flow chart depiction of Internet-based purchasing according to the present invention. When the person 1 buys or sell over the internet, the GAFS machine 3 can check for fraud/fake credit cards when buying or selling. In other words, the GAFS machine 3, in connection with its smart chip technology, may well function to verify or authenticate whether a cellular telephone or credit card having embedded smart chip technology is being properly used as a vehicle to effect purchases. It is contemplated that when a person 1 enters a website 54 and sees a good to be purchased (as at 104 in FIG. 43), he or she may enters the website and input a cellular telephone number into the website.

The person 1 then dials a code for credit to buy goods/services. For example, the person 1 may dial up a phone number as at 105 provided at the website. Certain GAFS machinery 3 may then check input data or number information against accounting codes for complete match for security. The GAFS unit then awaits a response from the web-site server as to what items are being sold or bought, as well as the total price of the transaction. The person 1 at the website 54 can then be asked to verity whether the order is correct. If the order is not correct, the order may be re-input or voided. If the order is correct, the web-site 54 may receive a go-ahead code from the GAFS machine 3 to complete the transaction to the buyer or the seller. Then the buyer or seller enters the go-ahead code into the cell phone 26 or website 54 to complete the transaction. It is contemplated that if the buyer or seller 1 does not enter the go-ahead code, then the transaction may be voided out for security reasons and the person 1 will not be billed or credited to a person's 1 funded account.

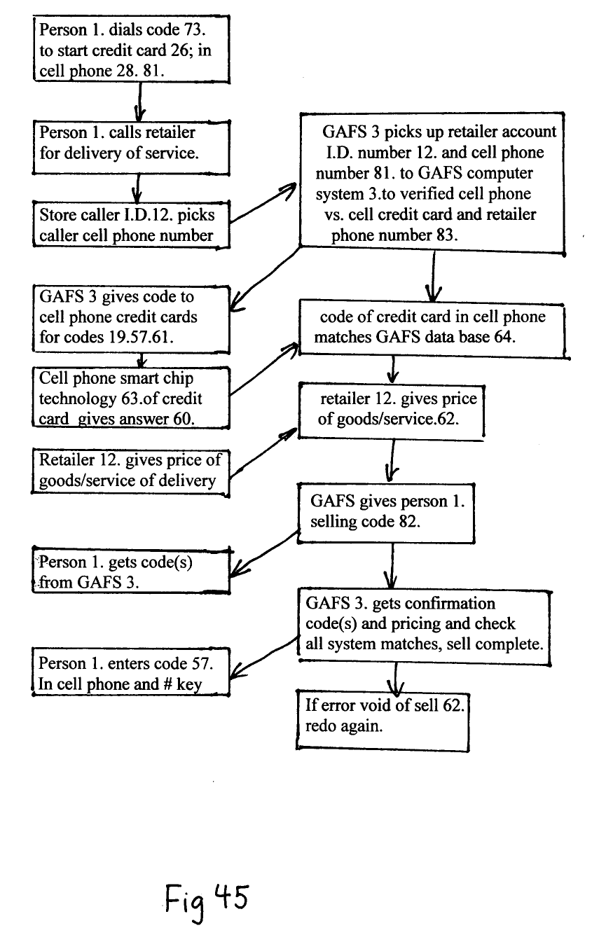

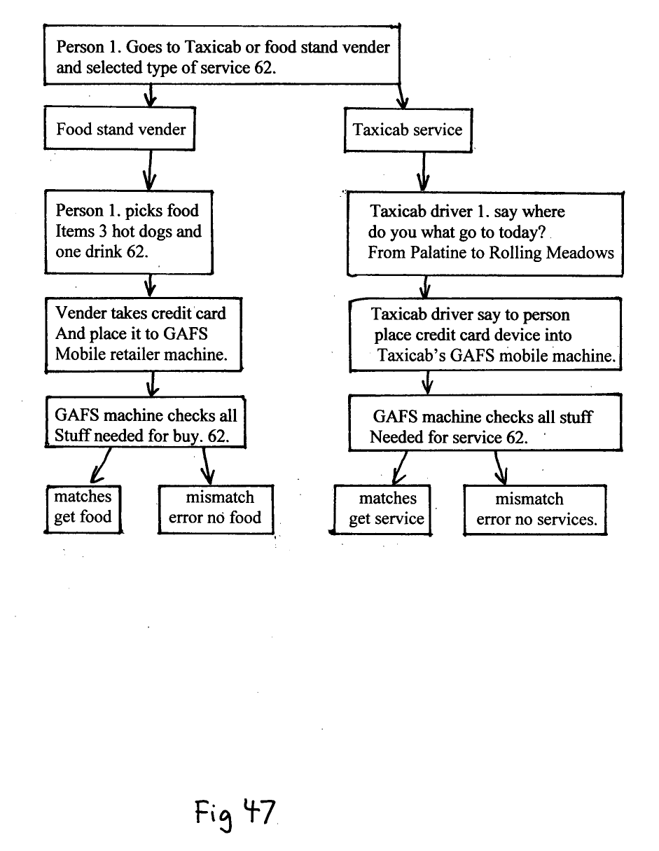

FIG. 45 is a flow chart depiction of a delivery transaction according to the present invention; FIG. 46 is a mobile GAFS credit machine according to the present invention; and FIG. 47 is a flow chart type depiction of the mobile credit machine otherwise depicted in FIG. 46 being used for two types of transactions, namely, a food vendor and taxi service. Should the user 1 wish to purchase pizza and pizza delivery service, and the user 1 wants to place an order to be delivered at home or the office, the user 1 may dial an authentication code on his or her cellular telephone 26 to initiate cellular telephone credit purchasing. After entering the authentication code, the user 1 may then dial the pizza delivery establishment's business telephone number. Certain GAFS machinery 3 then checks all systems while waiting for the transaction price to be entered from the vendor establishment. After the transaction amount is entered, the user 1 may approve of the transaction in which case the transaction is allowed to proceed, or disapprove of the transaction in which case the transaction is terminated.

It is contemplated that the go-ahead code may be provided the user 1 by the vendor establishment 12 for security reasons. The vendor establishment may log the cellular telephone 26 by way of smart chip codes embedded therewith. The GAFS machine 3 gets the cell phone number 26 and its activation code also checking the retailer identification codes of the business for a match. The GAFS machine 3 at the same time is checking cell phone credit card codes for a match with the cell phone 26 and GAFS for security reasons.

The invention further contemplates a mobile GAFS machine 3 for mobile services such as taxi cab service and the like. In this regard, the mobile GAFS device is for taxi cabs and other mobile services that can bill the person for services or goods (e.g. foods or beverages purchased from the livery service. It is contemplated that the mobile GAFS device is substantially similar to the GAFS machine 3 earlier specified and comprises certain means for billing. The person 1 thus picks a service, either a taxi or food vendor. The person 1 picks a select service or good and pays for it to complete the sale. It would be the taxi at the end of the trip or the vendor at the point of sale. The mobile credit card machine 3 will require transaction authentication from the person 1 in the form of a credit-enabled driver's license or similar other means of identification, a credit card with the smart chip technology, or a cellular telephone with smart chip technology.

When the person places a fake cell phone call, it is contemplated that the GAFS machine or system will allow the calls to be recorded. GAFS may thus function to maintain a log of calls and sees where, when and what time other calls go out to see a network of calls to see what operation of crime can be found. For example, a call in Chicago goes to New York City. The GAFS notes the location(s) of the call sender and receiver. Cameras may then be prompted to start recording images of the caller, recipient, associated vehicles, etc., as the person moves multiple pictures are being taken to see who the recipient is. The GAFS security system works when the phone is being used or not, as long as the phone power is on, the position of phone is known. GAFS is computerized, it is independent from human input, the system at GAFS will make call to all given areas to respond to the system needs to comprehend any problem that arises. The system interacts with people at all levels in system and integrates all programs of security, when it is necessary to get into other systems.

While the above descriptions contain much specificity, this specificity should not be construed as limitations on the scope of the invention, but rather as an exemplification of the invention. For example, it is contemplated that the present invention essentially teaches a system, device, and method for authenticating and tracking purchases and thus for preventing fraudulent purchases in real time. It is contemplated that the systemic aspects of the present invention essentially comprise a personal send-receive unit which is essentially a personalized, hand-held electronic payment device and position-indicating device. The position-indicating device is enabled by way of a global positioning system cooperable therewith. The personal send-receive unit comprises means for verifying or authenticating device usage by a single designated user, signal transmitting means for wirelessly transmitting a purchasing signal to a vendor establishment and for wirelessly transmitting positioning signals intermediate a global navigation satellite system. The signal transmitting means of the personal send-receive unit are thus operable to (1) effect a secure purchase at a vendor establishment and (2) globally track the single user or personal send-receive unit in real-time via a global navigation satellite system.

The system further comprises a vendor establishment (such as retailer 12), which vendor establishment comprises means for wirelessly receiving transmitted purchasing signals from the personal send-receive unit and means for processing the received purchasing signals. The vendor establishment essentially functions to fill an order as requested by the single designated user via the purchasing signals. A financial system is also required so as to satisfy or settle fund indebtedness. In this regard, the financial system or establishment is in communication with the vendor establishment and comprises certain means for receiving, holding, and sending single user finds. It is contemplated that the financial system functions to electronically send single user funds to the vendor establishment for electronic funds settlement.

The global navigation satellite system of the purchase-authenticating system preferably comprises a space segment, a control segment, and a user segment. The space segment comprises at least three Earth-orbiting satellites. The control segment functions to governing clock time and the orbital paths of the Earth-orbiting satellites. The user segment may be defined by the personal send-receive unit. The global navigation satellite system essentially functions to determine the real-time global location and velocity of the personal send-receive unit.

Certain means for globally tracking the personal send-receive unit in real-time are thought to also be necessary for tracking the personal send-receive unit in real time. In this regard, it is contemplated that the means for globally tracking the personal send-receive unit in real-time may comprise certain road-side mounted surveillance systems for capturing bird's eye visual information on a user carrying the personal send-receive unit.

The means for authenticating device usage by the single user functions to preventing fraudulent use of the personal send-receive unit by a second user. The personal send-receive unit enables the single user to transmit a purchasing signal to the vendor establishment for effecting a purchase. The vendor establishment receives the transmitted purchasing signal, processes the purchasing signal via the financial system for receiving electronic funds settlement, and provides a processed order to the single user. Together, the personal send-receive unit, the vendor establishment, the financial system, the global navigation satellite system and the means for tracking the personal send-receive unit in real time function to prevent fraudulent purchases in real time.

The system of the present invention may preferably comprise a unit-issuing center as may be defined by the GAFS machine 3. Notably, the unit-issuing center preferably comprises various means for inputting user-specific information (such as camera input means, fingerprint input means, and vocal input means. The center further comprises certain means for linking the user-specific information to the personal send-receive unit. In this regard, it is contemplated that the smart chips are encoded with user-specific and authenticating information, which smart chips are then cooperably associated with the personal send-receive unit (as may be configured in any number of hand-holdable devices). The center may further comprise certain means for issuing the personal send-receive unit to a bona fide user, as for example, by way of an issuing agent at a governmental agency of the like.

The personal send-receive unit of the GAFS system may further preferably comprise an antenna, a receiver-processor, and a clock. The antenna is preferably tuned to signals transmitted by the global navigation satellite system, and the clock is periodically updatable for enhancing the means for tracking the personal send-receive unit in real time. The personal send-receive unit may further comprise a visual display for visually displaying location and velocity information to the single user.

Certain methodology for preventing fraudulent purchases in real time is further contemplated as being supported by the foregoing specifications. In this regard, the method according to the present invention is believed to comprise a series of steps, including carrying a personal send-receive unit to a vendor establishment area; authenticating device usage by a single user of the personal send-receive unit; simultaneously transmitting a purchasing signal to a vendor establishment and positioning signals intermediate the personal send-receive unit and a global navigation satellite system; processing received purchasing signals at the vendor establishment for filling an order as requested by the single user; communicating with a financial system via the vendor establishment for effecting secure electronic funds settlement; and globally tracking the personal send-receive unit in real-time via the global navigation satellite system and a global tracking device.

The vendor establishment may provide a processed order to the single user after processing received purchasing signals at the vendor establishment or the vendor establishment may provide a processed order to the single user after communicating with the financial system via the vendor establishment for effecting secure electronic funds settlement. The step of periodically updating a clock housed within the personal send-receive unit may well function to enhance real time tracking of the personal send-receive unit. The steps of monitoring and controlling the global navigation satellite system may also function to enhance real time tracking of the personal send-receive unit. The method may further comprise the step of visually displaying location and velocity information to the single user; deactivating the personal send unit during the step of authenticating device usage if the single user cannot be authenticated; the step of alerting authorities as to the real time global position of the personal send-receive unit if the single user cannot be authenticated during the step of authenticating device usage. Further, the step of globally tracking the personal send-receive unit in real-time may preferably comprises real-time road-side surveillance.

The method may further comprise the step of issuing the personal send-receive unit to the designated user before carrying the personal send-receive unit to the vendor establishment area. In this regard, it is contemplated that the method may also comprise the step(s) of inputting user-specific information into a global anti-fraud system machine, such as the GAFS machine 3, which machine 3 may well function to encode the input user-specific information into the personal send-receive unit before issuing the personal send-receive unit to the designated user. Before the designated user is allowed to leave the GAFS machine 3 with the encoded personal send-receive unit, it is contemplated that the personal send-receive unit may be checked to insure proper operation of the unit before issuing the same to the designated user.

The method and apparatus for GAFS computer system, comprising a unit-issuing center comprising means for inputting user-specific information. The issuing-unit GAFS computer system makes positive identification of individuals to ensure that person is that person, not somebody else. In the method and apparatus of GAFS identifying center is used on all types of usages of GAFS system, getting ID, new secure credit card(s) and cell phone, etc. The method and apparatus of GAFS is a network of a secure communications for transaction of buying and selling, also verifying one's identity ensuring the buying or selling of product or service is the correct person. The method and apparatus of GAFS computer system is a modified retailer machine that integrated into an existing retailer machine. The machine (GAFS) operates at all levels of transactions, with all possible ways to execute transactions. The machine (GAFS) in method and apparatus to verify the authenticity of the person's identification that is buying and selling for an authentication positive ID match.

In method and apparatus of GAFS computer system is verifying the line of credit, mobile telecommunication device, cell phone or credit cards or any items that need security to ensure the authenticity of the items by the coding system within the smart chip technology. The method and apparatus of GAFS computer system also reads information on personal checks, money orders, traveler's checks or any form of documents to ensure the funds are available and are authentic items, not counterfeit or bogus checks. The method and apparatus of the GAFS computer system has the ability to see the funds are available in one's checking account(s). If funds are available GAFS computer system in method and apparatus will lock out the funds into retailer or any other accounts and show up in real time on new balances in a person's account. Also, the method and apparatus of this technology is used to set up business accounts.

The method and apparatus of GAFS smart chip technology is an encoding system within the chip. The chip is able to receive information from the GAFS computer system database and give out an answer to the GAFS system. The method and apparatus of smart chip technology within the GAFS computer system talks to the chip within the item of choice. The chip receives information from the GAFS database and responds. The method and apparatus of talking of smart chip technology has the computer system (GAFS) reading the credit card information and the chip within the credit card received energy and information from the database of GAFS. In method and apparatus the chip responds back by giving an answer back from the chip's files of codes from within the chip to the question of the GAFS question. In method and apparatus each smart chip technology has it's own unique, one of a kind encoded/coding system within each smart chip technology. In method and apparatus no chip has the same information of the coding system from one chip to another chip.

In method and apparatus no two chips are more alike in what type of questioning it receives from GAFS computer system of questioning codes and what type of answer given out by smart chip technology. Also, more than one question or answers is given out by GAFS and/or smart chip technology. In method and apparatus the computer system of GAFS can rearrange the codes within the chip when the smart chip technology is turned on as a security measure. In method and apparatus the computer system of GAFS randomly picks a new and different arrangement of coding within the chip. In method and apparatus of GAFS computer system is used at the retailer, mobile retailer credit device taxicab, vendor outlets, and/or any other locations where GAFS technology is needed. In method and apparatus the computer system of GAFS provides the following: checks the physical attributes of the person, eg. photo matching, fingerprints, voice recognition and/or any other means to verify the authenticity of the individual.

In the method and apparatus of smart chip technology the secured coding system goes into personal identification, mobile telecommunication device, credit cards, cell phone, and/or any other security items of one's choice. The method and apparatus of smart chip technology within any item of choice or needs is the independent item being used, eg credit card. The credit card has its own information about the credit card. The smart chip technology with its codes is a separate item from the credit card information. In method and apparatus they both work together on the same card, the card information is one item. The smart chip technology works with the credit card or any other item with smart chip technology to verify the credit card authenticity vs. counterfeit or bogus credit card.

In method and apparatus the information of the credit card or any other item and with smart chip technology can be made into one computer chip. The information of the two items is unique and serves as two separate items of information within the same chip. The method and apparatus of coding on the money orders, traveler's checks or any other documents of importance. The coding on the item of choice, eg traveler's checks has printed codes on the face, back of check or both sides of the traveler's checks from GAFS computer system and encoding. The method and apparatus of the coded checks or documents can be from multiple GAFS computer systems. For example, the bank of issue has it's own coding system, GAFS own coding system and/or the corporation of the check is made by American Express, with its own coding system for security.

In method and apparatus of all GAFS retailer machine devices are able to read the information checks or documents. This is to verify the authenticity of the check or any other item with it's printed codes to ensure the protection from counterfeit/fraudulent check(s) or any other form of documents. The method and apparatus of GAFS retailer machines at all locations and all types of GAFS mobile retailer machines are able to verify the person's identification, fingerprints, take photo snapshot, take video snapshot at the point of buying or selling. The method and apparatus of GAFS to call the person, or receive phone calls from the person at any type of GAFS retailer machine. Also, as an added security measure it would be able to take the security pin codes from the buyer or seller on the keyboard of the GAFS retailer machine. The machine is also able to read implant chip technology. It is able to translate all languages and talk back in any language.

The method and apparatus of GAFS retailer machine, GAFS computer system, coding system and its security system is integratable to all new forms of technology for the insurance of the maximum security of the GAFS system. In method and apparatus of the GAFS system it is upgradeable to all new types of identifying technologies of identification. The method and apparatus of the GAFS computer system has its own security system. To protect the system from hackers, identity-theft criminals, credit card fraud, fake cell phone and fake business account(s) and from violating the GAFS computer system for the purpose of getting approved credit, service or access by fraudulent means. The method and apparatus of GAFS security system comprises multiple areas of security measures to apprehend criminals to the GAFS computer system. Some of the methods of apprehending criminals include cameras inside of buildings, cameras outside of buildings, cameras on the highway system, global tracking device, the latest technology of the military tracking system in the movement of an individual in real time.

The method and apparatus of GAFS computer system is modifiable to all types of security systems and all types of networks of communications and is possible at all levels. The method and apparatus of GAFS security system has the abilities to track down any electronic device to pinpoint its location, it also has the ability to hunt down license plates of vehicles in true real time in any given region needed. The method and apparatus of GAFS security system can be used to non-GAFS security means. For example, if a bank is robbed the GAFS security system will apprehend the criminals. The method and apparatus of GAFS retailer machine has a hand held mobile device version of the GAFS retailer machine. This machine is capable of performing all the functions of the main GAFS machine at the retailer level to verify the ID of a person and will accept credit cards. The method and apparatus of the hand held device is useful in delivering goods or a service. For example, UPS or a pizza delivery person can check the ID when receiving goods or services.

The method and apparatus to place or build a line of credit card(s) within a cell phone, mobile telecommunication device or any other device to have the line of credit card(s) that uses smart chip technology to GAFS. The method and apparatus of the cell phone, mobile communication device, electronic device or other device, e.g. IPODS compressed within a magnetic strip of a credit card built within the cell phone. The method and apparatus magnetic strip within the cell phone or any electronic device does work together with smart chip technology. Also, this is for a cell phone, electric devices or mobile telecommunication device that does not have smart chip technology in it.

The method and apparatus of the credit card magnetic strip device in any mobile wireless telecommunication device and non-electric device can be made to flop out, pull out manually or be electronically removed. There is a third hidden flip out door which slides out sideways or any other way fitting to the manufacturer's way of designing of produced being in used with the magnetic strip with the line of credit. The method and apparatus of a holding compartment(s) to store credit card(s) or any other item(s) within the cell phone, mobile telecommunication device or any other electric device to pull out the credit card(s) out of the item of choice to be used to make buys or sells with one's credit.

The method and apparatus of the cell phone credit card with smart chip technology, without smart chip technology or the credit card with the magnetic strip within the device of the cell phone, electric device or mobile telecommunication device has an extra security measure. The line of credit can be in a turn off mode at will, it can be turned back on at will and can set limits of funds to be used from a person's credit card limits. What this means is that the rightful owner or user can dial up a code or call the financial institution to turn off the funds or funds on the line of credit on credit card(s) or business accounts. It can also set limits of funds to be used. The method and apparatus of credit card security in the matter of claim in “off mode, on mode and set limits to be used” is applicable to standard credit cards which can have the same feature of being turned off at will, to turn on at will and set limits of funds to be used. The method and apparatus of GAFS and/or financial institution can set up its own type of security codes in getting credit in the turn off mode and on mode with limits.

Accordingly, although the invention has been described by reference to certain preferred systemic components, preferred embodiments of the personal send-receive unit hardware, and certain methodology otherwise believed to be supported by the inventive concepts set forth in the foregoing specifications, it is not intended that the novel system, device, and method for preventing fraudulent purchasing be limited thereby, but that modifications thereof are intended to be included as falling within the broad scope and spirit of the foregoing disclosure, the following claims and the appended drawings.

I claim:

1. A global anti-fraud computer system, the global anti-fraud computer system comprising a unit-issuing center, the unit-issuing center comprising means for inputting user-specific information, the unit-issuing center for positively identifying individuals, the positively identified individuals for ensuring that the user is a verifiable user.

2. The global anti-fraud computer system of claim 1 wherein the unit-issuing center issues new identification cards, secure credit cards, and cellular telephones.

3. The global anti-fraud computer system of claim 1 comprising a network of secure communications, the network of secure communications for enabling the transaction of buying and selling, the global anti-fraud computer system for verifying a user's identity during a purchase or sale of product or service.

4. The global anti-fraud computer system of claim 3 being defined by a modified retailer machine, the modified retailer machine operating at all levels of transactions, with all possible ways to execute transactions, the modified retailer machine being used to verify authenticity of a user's identification during a buying or selling transaction.

5. The global anti-fraud computer system of claim 1 comprising document-reading means for reading information on personal checks, money orders, traveler's checks or any form of document, the system thus for ensuring document-supported funds are available and that the documents are authentic items

6. The global anti-fraud computer system of claim 5 wherein the system has the ability to determine whether funds are available in one's checking account, if funds are available, the system will lock out the funds into a retailer account, new business account, or any other account and show up in real time on new balances in a person's account.

7. The global anti-fraud computer system of claim 1 wherein the system comprises a coding system with smart chip technology, the system for verifying lines of credit, mobile telecommunication device, cellular telephones, credit cards or any securable items, the system thus for ensuring the authenticity of the securable items by the coding system within the smart chip technology.

8. The global anti-fraud computer system of claim 5 wherein the smart chip technology is an encoding system within the chip, the chip being able to receive information from a system database and provide the system with an answer.

9. The global anti-fraud computer system of claim 6 wherein the smart chip technology within the system talks to the chip within an item of choice, the chip receiving information from the system database and responding.

10. The global anti-fraud computer system of claim 7 wherein the system talks via smart chip technology and reads credit card information from a card-embedded chip, the card-embedded chip responding to system inquiries by giving back an answer back from the chip's files of codes from within the chip to system's inquiries.

11. The global anti-fraud computer system of claim 10 wherein each smart chip has a unique encoded/coding system.

12. The global anti-fraud computer system of claim 11 wherein each smart chip receives a unique question from the system as determined by question codes, each smart chip thereby providing a unique answer.

13. The global anti-fraud computer system of claim 12 wherein each smart chip and receive a plurality of questions and provide a plurality of answers.

14. The global anti-fraud computer system of claim 13 wherein the codes within the chip are re-arrangeable when the smart chip technology is turned on as a security measure.

15. The global anti-fraud computer system of claim 14 wherein the system randomly picks a new and different arrangement of coding within the chip.

16. The global anti-fraud computer system of claim 1 usable at the retailer, mobile retailer credit device taxicab, vendor outlets, and/or any other locations where GAFS technology is needed.

17. The global anti-fraud computer system of claim 16 wherein the verifies physical attributes of the user, including photo matching, fingerprints, voice recognition and/or any other means to verify the authenticity of the individual.

18. The global anti-fraud computer system of claim 17 wherein the secured coding system of smart chip technology goes into personal identification, mobile telecommunication device, credit cards, cell phone, and/or any other security items of one's choice.

19. The global anti-fraud computer system of claim 18 wherein the smart chip technology associated with an item of choice is the independent of the item being used.

20. The global anti-fraud computer system of claim 18 wherein the information of the credit card or any other item and with smart chip technology can be made into one computer chip, the information of two items being unique and serving as two separate items of information within the same chip.

21. The global anti-fraud computer system of claim 20 wherein the coding on money orders, traveler's checks or any other documents of importance comprises printed codes on the face, back of check or both sides of the traveler's checks, the printed codes being provided by the system.

22. The global anti-fraud computer system of claim 21 wherein the coded checks or documents can be from multiple systems.

23. The global anti-fraud computer system of claim 22 wherein retailer machine devices are able to read the printed codes on checks or documents, the readable codes for verifying the authenticity of the check or any other item with it's printed codes to ensure the protection from counterfeit/fraudulent check(s) or any other form of documents.

24. The global anti-fraud computer system of claim 23 wherein retailer machine devices at multiple locations are able to verify the person's identification, fingerprints, take photo snapshot, take video snapshot at the point of buying or selling.

25. The global anti-fraud computer system of claim 24 comprising means for placing a telephone call to the user, and means for receiving telephone calls from the user at any type of retailer machine.

26. The global anti-fraud computer system of claim 25 comprising means for reading security pin codes from the buyer or seller on the keyboard of the retailer machine.

27. The global anti-fraud computer system of claim 26 comprising means for reading implant chip technology.

28. The global anti-fraud computer system of claim 27 comprising means for translating and interacting in multiple languages

29. The global anti-fraud computer system of claim 4 wherein the retailer machine, computer system, coding system and its security system are integratable to all new forms of technology for the insurance of the maximum security of the system.

30. The global anti-fraud computer system of claim 29 wherein the system is upgradeable to all new types of identifying technologies of identification.

31. The global anti-fraud computer system of claim 1 comprising a self-contained security system, the self-contained security system for protecting the system from hackers, identity-theft criminals, credit card fraud, fake cell phone and fake business account(s) and from violating the system for the purpose of getting approved credit, service or access by fraudulent means.

32. The global anti-fraud computer system of claim 31 wherein the security system comprises multiple areas of security measures to apprehend criminals via the system, the system comprising cameras inside of buildings, cameras outside of buildings, cameras on the highway system, global tracking device, the latest technology of the military tracking system in the movement of an individual in real time.

33. The global anti-fraud computer system of claim 32 wherein the system is modifiable to all types of security systems and all types of networks of communications and is possible at all levels.

34. The global anti-fraud computer system of claim 33 comprising means for tracking down any electronic device to pinpoint its location, it also has the ability to hunt down license plates of vehicles in true real time in any given region needed.

35. The global anti-fraud computer system of claim 34 wherein the security system cooperates with non-GAFS security means.

36. The global anti-fraud computer system of claim 35 employable at a retailer machine, the retailer machine comprising a hand held mobile device version of the retailer machine, the hand held mobile device version being capable of performing all the functions of the main retailer at the retailer level to verify the identification of a user and accepting credit cards, the hand held mobile device version being useable for delivering goods or services.

37. The global anti-fraud computer system of claim 36 comprising means for placing or building a line of credit card(s) within a cell phone, mobile telecommunication device or any other device to have the line of credit card(s) that uses smart chip technology.

38. The global anti-fraud computer system of claim 37 wherein the cell phone, mobile communication device, electronic device or other device comprises a magnetic strip, the magnetic strip cooperates with smart chip technology, the cooperative magnetic strip for cooperating with cell phones, electric devices or mobile telecommunication devices having no smart chip technology.

39. The global anti-fraud computer system of claim 38 wherein the magnetic strip can be made to flop out, pull out manually or be electronically removed.

40. The global anti-fraud computer system of claim 39 comprising holding compartment(s) to store credit card(s) or any other item(s) within the cell phone, mobile telecommunication device or any other electric device to pull out the credit card(s) out of the item of choice to be used to make buys or sells with one's credit.

41. The global anti-fraud computer system of claim 40 comprising extra security means, the extra security means being operable by the user or the institution for turning off mode lines of credit at will, the lines of credit being turned back on at will, the lines of credit having preset limits.

42. The global anti-fraud computer system of claim 41 wherein the off mode, on mode, and set limits to be used mode is applicable to standard credit cards which can have the same feature of being turned off at will, to turn on at will and set limits of funds to be used.

43. The global anti-fraud computer system of claim 42 wherein the institution in which the system is located can set up its own type of security codes in getting credit in the turn off mode and on mode with limits.
